(19) United States
(12) Patent Application Publication
(10) Pub. No.: US 2003/0001880 A1
(43) Pub. Date: Jan. 2, 2003

(54) Method, system, and computer program product for producing and distributing enhanced media

(75) Inventors: Alex Holtz, Jacksonville, FL (US); Robert J. Snyder, St. Augustine, FL (US); Marcel LaRocque, Jacksonville, FL (US); William H. Couch, Fernandina Beach, FL (US); Benjamin McAllister, Jacksonville, FL (US); Charles M. Hoeppner, Jacksonville, FL (US); Keith Gregory Tingle, Neptune Beach, FL (US); David A. Armbruster, Jacksonville Beach, FL (US)

Correspondence Address: STERNE, KESSLER, GOLDSTEIN & FOX PLLC, 1100 NEW YORK AVENUE, N.W., SUITE 600, WASHINGTON, DC, 20005-3934, US

(73) Assignee: ParkerVision, Inc.

(21) Appl. No.: 10/208,810

(22) Filed: Aug. 1, 2002

Related U.S. Application Data
(63) Continuation-in-part of application No. 09/836,239, filed on Apr. 18, 2001.
(60) Provisional application No. 60/309,788, filed on Aug. 6, 2001.
(60) Provisional application No. 60/386,753, filed on Jun. 10, 2002.

(51) Int. Cl. G09G 5/00

(52) U.S. Cl. 345/716

(57) ABSTRACT

A method, system, and computer program product are provided to edit and encode enriched multimedia productions for live, delayed, or on-demand web casts or other distribution. The present invention is configured to operate independent of the system platform and media format. Hence, the present invention has the ability to operate with any type of manual or automated video production system. The multimedia production is produced according to an electronic show rundown. The rundown includes instructions for encoding the production for webcasting. In an embodiment, the multimedia is produced and broadcast over conventional channels simultaneously with a live or delayed web cast. The web cast material is edited, fragmented, tagged and/or archived during the simulcast. In another embodiment, the multimedia is produced and archived for on-demand web cast. Auxiliary information is added to enhance the multimedia production. Auxiliary information includes web sites, extended video segments, related media productions, advertisements, and the like. During pre-production, production, or post-production, auxiliary information can be altered or deleted for web casts. The encoding process permits the enriched multimedia to be partitioned, cataloged, and indexed for personalized viewing over the Internet. A user can select one or more events from a menu of categorized media productions, determine an order for viewing, and receive a seamless assembly of productions.

This application is a continuation-in-part of U.S. patent application Ser. No. 09/836,239, filed Apr. 18, 2001, by Holtz et al., entitled “Method, System and Computer Program Product for Producing and Distributing Enhanced Media Downstreams,” incorporated herein by reference in its entirety.

This application also claims the benefit of U.S. Patent Application Serial No. 60/309,788, filed Aug. 6, 2001, by Holtz, entitled “Webcasting and Business Models,” incorporated herein by reference in its entirety, and the benefit of U.S. Patent Application Serial No. 60/386,753, filed Jun. 10, 2002, by Holtz et al., entitled “Method, System and Computer Program Product for Producing and Distributing Enhanced Media,” incorporated herein by reference in its entirety.

### CROSS-REFERENCE TO RELATED APPLICATIONS

The following United States and PCT utility patent applications have a common assignee and contain some common disclosure:

“Real Time Video Production System and Method,” U.S. patent application Ser. No. 09/215,161, by Holtz et al., filed Dec. 18, 1998, incorporated herein by reference;

“System and Method for Real Time Video Production and Multicasting,” U.S. patent application Ser. No. 09/482,683, by Holtz et al., filed Jan. 14, 2000, incorporated herein by reference;

“System and Method for Real Time Video Production and Multicasting,” U.S. patent application Ser. No. 09/488,578, by Snyder et al., filed Jan. 21, 2000, incorporated herein by reference;

“System and Method for Real Time Video Production and Multicasting,” U.S. patent application Ser. No. 09/634,735, by Snyder et al., filed Aug. 8, 2000, incorporated herein by reference;

“System and Method For Real Time Video Production and Multicasting,” PCT Patent Application Serial No. PCT/US01/00547, by Snyder et al., filed Jan. 9, 2001, incorporated herein by reference;

“Method, System and Computer Program Product for Full News Integration and Automation in a Real Time Video Production Environment,” U.S. patent application Ser. No. 09/822,855, by Holtz et al., filed Apr. 2, 2001, incorporated herein by reference;

“Method, System and Computer Program Product for Full News Integration and Automation in a Real Time Video Production Environment,” PCT Patent Application Serial No. PCT/US01/10306, by Holtz et al., filed Apr. 2, 2001, incorporated herein by reference;

“Interactive Tutorial Method, System and Computer Program Product for Real Time Media Production,” U.S. patent application Ser. No. 09/832,923, by Holtz et al., filed Apr. 12, 2001, incorporated herein by reference;

“Distance Learning Curriculum and System,” U.S. Patent Application Serial No. 60/309,880, by Holtz, filed Aug. 6, 2001, incorporated herein by reference;

“Advertisement Management Method, System, and Computer Program Product,” U.S. Patent Application Serial No. 60/323,328, by Holtz, filed Sep. 20, 2001, incorporated herein by reference; and

“Sales Module to Support System for On-Demand Internet Deliver of News Content,” U.S. Patent Application Serial No. 60/363,098, by Holtz, filed Mar. 12, 2002, incorporated herein by reference.

### BACKGROUND OF THE INVENTION

1. Field of the Invention

The present invention relates generally to media production, and more specifically, to distributing live or live-to-tape media productions over a communications network.

2. Related Art

Conventionally, the production of a live or live-to-tape video show (such as a network news broadcast, talk show, or the like) is largely a manual process involving a team of specialized individuals working together in a video production environment having a studio and a control room. The video production environment is comprised of many diverse types of video production devices, such as video cameras, microphones, video tape recorders (VTRs), video switching devices, audio mixers, digital video effects devices, teleprompters, and video graphic overlay devices, etc.

In a conventional production environment, the video production devices are manually operated by a production crew (which does not include the performers and actors, also known as the “talent”) of artistic and technical personnel working together under the direction of a director. A standard production crew is made up of nine or more individuals, including camera operators (usually one for each camera, where there are usually three cameras), a video engineer who controls the camera control units (CCUs) for each camera, a teleprompter operator, a character generator operator, a lighting director who controls the studio lights, a technical director who controls the video switcher, an audio technician who controls an audio mixer, tape operator(s) who control(s) a bank of VTRs, and a floor director inside the studio who gives cues to the talent.

Typically, the director coordinates the entire production crew by issuing verbal instructions to them according to a script referred to as a director's rundown sheet. Generally, each member of the production crew is equipped with a headset and a microphone to allow constant communication with each other and the director through an intercom system. The video produced by crew is delivered or transmitted to a master control system that, in turn, broadcasts the video over traditional mediums to a television set. Traditional mediums include the appropriate ranges of the frequency spectrum for television, satellite communications, and cable transmissions. The global Internet and other computer networks present a new distribution medium for video productions and like.

Therefore, what is needed is a media production and distribution system and method that are adapted for traditional and other distribution mediums.

### SUMMARY OF THE INVENTION

A method, system and computer program product are provided to produce, edit, store, and/or distribute enhanced media productions, including news programs, television programming (such as, documentaries, situation comedies, dramas, variety shows, interviews, or the like), sporting events, concerts, infomercials, movies, video rentals, or any other content. In an embodiment, the media production is tagged, partitioned, and organized automatically so that it can be broadcast over traditional mediums (e.g., airwaves, cable, satellite, etc.) and/or network infrastructure (including the global Internet).

In an embodiment, the present invention combines automated and/or manual media production, webcasting, and additional technology to achieve a delivery system that is operable to stream various forms of media over, for example, the World Wide Web where each user receives live or customized programming on demand. Advertising is linked to portions of each production so that the user when viewing the live or customized programming also views the associated advertising.

In an embodiment, the present invention also links other forms of auxiliary information, including advertisements, to enrich or enhance the content of a production. Auxiliary information includes extended video/audio, hyperlinks to related web sites, email addresses, statistics, related documents, etc. The production is configured such that specified auxiliary information is presented to a user when its corresponding portion of the production also is being presented.

In an embodiment, the present invention is adapted to produce and encode a media production for computer network distributions concurrently with an original broadcast over traditional mediums. In an embodiment, the network distribution is executed and delivered to a display or other data processing device at substantially the same time as the broadcast over traditional mediums.

An embodiment of the present invention enables the association of auxiliary information to be modified at any time during pre-production, production, or post-production. Additionally, during a simulcast over traditional mediums and computer network mediums, embodiments of the present invention permit a production rundown for a network transmission to be modified and synchronized with changes made to a broadcast rundown.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable one skilled in the pertinent art(s) to make and use the invention. In the drawings, generally, like reference numbers indicate identical or functionally similar elements. Additionally, generally, the leftmost digit(s) of a reference number identifies the drawing in which the reference number first appears.

FIG. 1 illustrates an operational flow diagram for delivering parallel live productions according to an embodiment of the present invention.

FIG. 2 illustrates an operational flow for formatting media for transmissions according to an embodiment of the present invention.

FIG. 3 illustrates an operational flow diagram for delivering parallel live productions according to another embodiment of the present invention.

FIG. 4 illustrates an operational flow diagram for delivering parallel live productions according to another embodiment of the present invention.

FIG. 5 illustrates an operational flow diagram for delivering parallel live productions according to another embodiment of the present invention.

FIG. 6 illustrates an operational flow diagram for editing post-productions according to an embodiment of the present invention.

FIG. 7 illustrates an operational flow diagram for providing an enhanced media viewer according to an embodiment of the present invention.

FIG. 8 illustrates an operational flow diagram for requesting and distributing enhanced media according to an embodiment of the present invention.

FIG. 9 illustrates an enhanced media production and distribution system according to an embodiment of the present invention.

FIG. 10 illustrates an example computer system useful for implementing the present invention.

FIG. 11 illustrates an electronic rundown graphical user interface (GUI) according to an embodiment of the present invention.

FIG. 12 illustrates an electronic rundown GUI according to another embodiment of the present invention.

FIG. 13 illustrates an alternative view of the electronic rundown GUI of FIG. 11 or FIG. 12.

FIG. 14 illustrates an encode mark configuration GUI according to an embodiment of the present invention.

FIG. 15 illustrates an alternative view of the electronic rundown GUI of FIG. 11 or FIG. 12.

FIG. 16 illustrates an encode object configuration GUI according to an embodiment of the present invention.

FIG. 17 illustrates an electronic rundown GUI according to another embodiment of the present invention.

FIG. 18 illustrates an electronic rundown GUI according to another embodiment of the present invention.

FIG. 19 illustrates an operational flow diagram for fragmenting media according to an embodiment of the present invention.

FIG. 20 illustrates an enhanced media streamer according to an embodiment of the present invention.

FIG. 21 illustrates an enhanced media streamer according to another embodiment of the present invention.

FIG. 22 illustrates an enhanced media streamer according to another embodiment of the present invention.

FIG. 23 illustrates an electronic rundown GUI for a news automation system according to an embodiment of the present invention.

FIG. 24 illustrates stages for producing and distributing a media production according to an embodiment of the present invention.

FIG. 25 illustrates an operational flow diagram for requesting and distributing enhanced media according to another embodiment of the present invention.

FIG. 26 illustrates an operational flow diagram for requesting and distributing enhanced media according to another embodiment of the present invention.

FIG. 27 illustrates an operational flow diagram for requesting and distributing enhanced media according to another embodiment of the present invention.

FIG. 28 illustrates an operational flow diagram for requesting and distributing enhanced media according to another embodiment of the present invention.

FIG. 29 illustrates an operational flow diagram for requesting and distributing enhanced media according to another embodiment of the present invention.

FIG. 30 illustrates an operational flow diagram for requesting and distributing enhanced media according to another embodiment of the present invention.

FIG. 31 illustrates an operational flow diagram for requesting and distributing enhanced media according to another embodiment of the present invention.

### DETAILED DESCRIPTION OF THE INVENTION

### Table of Contents

I. Enhanced Media Production and Distribution

II. Producing Media for Parallel Distribution

III. Post-Production Disposition

IV. Benefit of Invention Using an Example Web Cast

V. System Overview of Enhanced Media Production and Distribution

VI. Enhanced Media Production and Storage

VII. Web Cast Production

VIII. Auxiliary Information

1. Advertisements

2. Supporting Information

3. Extended Audio-Video

4. Opinion Research

5. Hyperlinks to Related Sites

6. Methods of Entering Auxiliary Information

IX. Viewer Interface

1. Media Viewer

2. Viewer Controls

3. Media Index

4. Auxiliary Media

5. Opinion Media

6. Media Access Area

7. Banner

8. Alternative Skins

X. Conclusion

I. Enhanced Media Production and Distribution

In an embodiment of the present invention, live or live-to-tape media productions are encoded and transmitted over a computer network, such as the global Internet, a local intranet, private virtual networks, or any other communication network, medium, and/or mode. During the encoding process, auxiliary information is associated with stories or story elements within the media production, such that the auxiliary information is presented with the media production when it is streamed, downloaded, or otherwise transferred, transmitted, or provided to a display device.

As used herein, the term “media production” includes the production of any and all forms of media or multimedia in accordance with the method, system, and computer program product of the present invention. Additionally, the term “enhanced media” refers to a media production that has been supplemented according to the present invention to enhance the value and/or substance of the media production. In an embodiment, enhanced media is produced by associating auxiliary information, such as graphics, extended play segments, opinion research data, universal resource locators (URLs), advertisements, computer programs, Java or similar code, spreadsheets, audio in any format, video in any format, multimedia, or other auxiliary information deemed desirable. The term “live-to-tape” refers to a live media production that has been stored to any type of record playback device (RPD), including a video tape recorder/player (VTR), video recorder/server, virtual recorder (VR), digital audio tape (DAT) recorder, or any mechanism that stores, records, generates, or plays back via magnetic, optical, electronic, or any other storage media. It should be understood that “live-to-tape” represents only one embodiment of the present invention. The present invention is equally applicable to any other type of production that uses or does not use live talent (such as cartoons, computer-generated characters, animation, etc.). Accordingly, reference herein to “live” or “live-to-tape” is made for illustration purposes, and is not limiting.

As such, the method, system, and computer program product of the present invention enable an individual to view a real-time or customized media production, which is transmitted over a network (e.g., the World Wide Web), onto their personal computer (PC), personal digital assistant (PDA), telephone, or other display or data processing device. The media productions include, but are not limited to, video of news programs, television programming (such as, documentaries, situation comedies, dramas, variety shows, interviews, or the like), sporting events, concerts, infomercials, movies, video rentals, or any other content. For example, media productions can include streaming video related to corporate communications and training, educational distance learning, or home shopping video-based “e” or “t”-commerce. Media productions also include live or recorded audio (including radio broadcast), graphics, animation, computer generated, text, and other forms of media and multimedia.

In an “on-demand” embodiment, a live news program or other type of program (as noted above) is recorded at a hosting facility (e.g., television station, or other location(s)), segmented, categorized, and indexed for easy retrieval and viewing. These operations can be performed automatically using the PVTV Production Automation System™ (previously referred to in the applications cited above as the CameraManSTUDIO™ automation system) available from ParkerVision, Inc. of Jacksonville, Fla., although it is not necessary to use this system. Alternatively, these operations (or subsets thereof) can be performed manually. Examples of automated and manual media production systems are described in greater detail below.

In a “live broadcast” embodiment of the present invention, a media production is broadcast over traditional airwaves or other mediums (e.g., cable, satellite, etc.) to a television set. At the same time (or substantially the same time), the production is enhanced and encoded for distribution over a computer network. The traditional and network distribution modes/methods are synchronized and transmitted substantially at the same time. The distribution can be live or repurposed from previously stored media. In an embodiment, the media production is distributed only via a traditional medium. In another embodiment, the media production is distributed only over a computer network. In an embodiment, the computer network includes the Internet, and the enhanced media is formatted in hypertext markup language (HTML) for distribution over the World Wide Web. The network transmission or web cast is delivered to a display device within an approximate twenty-second delay from the live broadcast. However, the present invention is not limited to the Internet, and the transmission latency will vary based on a number of factors, such as geographies, equipment used, system loading, etc.

II. Producing Media for Parallel Distribution

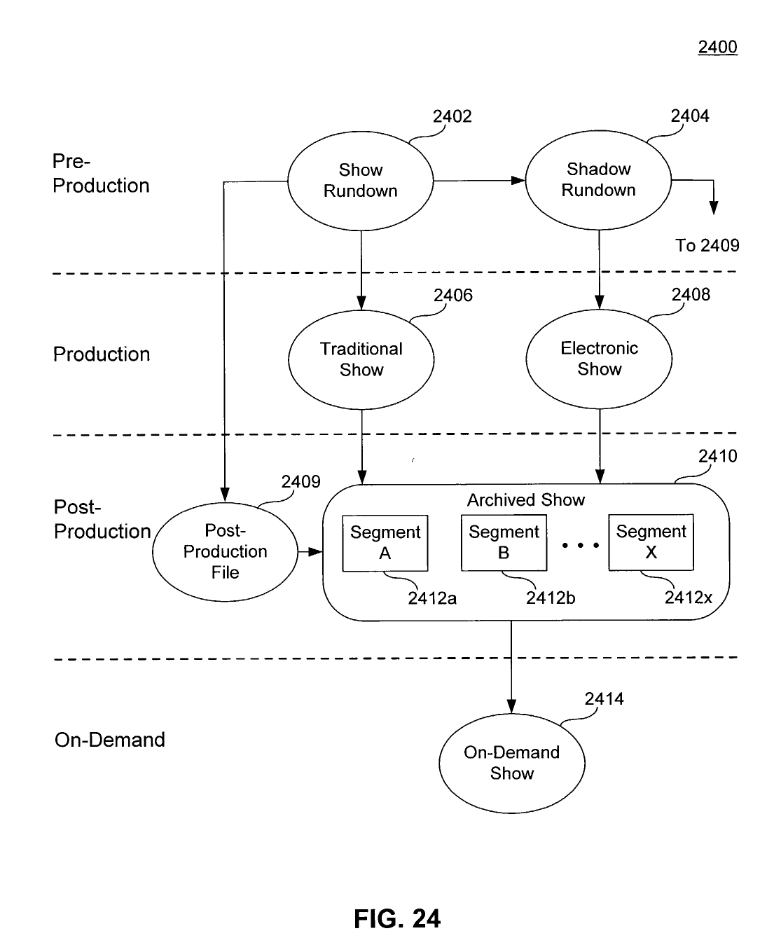

As discussed above, embodiments of the present invention support parallel distribution of a media production over different mediums (such as, a traditional medium and a computer network). FIG. 24 illustrates four stages in producing and distributing a media production in accordance with an embodiment of the present invention. As shown, the four stages include a pre-production stage, production stage, post-production stage, and on-demand stage. During the pre-production stage, a show rundown 2402 is planned and prepared by an appropriate member of the production crew. As an example, a show's producer, who is the architect of the show, typically prepares show rundown 2402 initially. The director then takes show rundown 2402, “marks it” (which is a term used in the broadcast industry to denote the adding of source and effect information), and subsequently coordinates the entire production crew by issuing verbal instructions to them according to the director's show rundown 2402.

In accordance with the present invention, show rundown 2402 can be implemented as a paper or electronic embodiment. As an electronic embodiment, show rundown 2402 can be executed to provide automated, semi-automated, or manual control of a show's production, as described in greater detail below.

During the production stage, the show's director steps through show rundown 2402 to issue media production instructions. As a result, the production crew operates the appropriate equipment to produce a traditional show 2406. In accordance with the present invention, traditional show 2406 is produced by manually operating the production equipment, or by using an automated or semi-automated production system. Traditional show 2406 (i.e., the media production) is captured and transmitted to master control. The master control system switches between feeds, local production, and/or commercial insertion. Master control sends a signal out to the transmitter and broadcasts traditional show 2406 over the airwaves or other traditional mediums and/or modes (such as cable, satellite, etc.).

During the post-production stage, traditional show 2406 is encoded and recorded to a storage medium as an archived show 2410. A post-production editing and approval application file 2409 is provided to modify, add, delete, or insert stories, extended play, or related story links, URLs, scripts, graphics, or other data, video, or text to enhance or edit the content for “on-demand” access. Post-production editing and approval application file 2409 enables one to edit or modify archived show 2410. Using post-production editing and approval application file 2409, one can recall all or part of archived show 2410, so that it can be “fine-tuned” via editing of the beginning or end of a segment or story. A story can be further segmented or deleted as necessary to only allow specific stories to be accessed for “on-demand” retrieval. The start and end of individual segments or stories are marked such that, once the stories are encoded, they become independent stories or portions thereof (shown as segments 2412a-2412x), and stored. One or more of segments 2412a-2412x are linked with metadata that includes a filename, an address or path to its storage location, or an address or path to any auxiliary information associated with segment 2412a-2412x. In addition, runtime data, story name, show name, segment length, date produced, and category of story segment are also stored and linked.

During the on-demand stage, the content archived during the post-production stage is queried for a subsequent viewing. As discussed, embodiments of the present invention support customized selection and viewing of archived content. As such, an on-line user can access an archived show 2410, select one or more segments 2412a-2412x, and request the selected segments 2412a-2412x to be transmitted to a display device in a specified order.

The four stages have been described with reference to a traditional distribution and post-production. However, the present invention permits a broadcast to be simultaneously or alternatively transmitted over a second (or more) distribution medium in parallel with the primary distribution. The primary distribution is shown in FIG. 24 by traditional show 2406.

The primary distribution can be “shadowed” by shadow rundown 2404 and electronic show 2408 for parallel or alternative distribution. In other words, during the pre-production stage, another member of the crew prepares or receives a shadow rundown 2404 that is based on show rundown 2402, or “marks” the same electronic rundown 2402 as a separate client, i.e., the director as opposed to the producer or “second” director. Shadow rundown 2404 includes instructions for formatting a media production to be transmitted over a computer network.

Shadow rundown 2404 is executed during the production stage to thereby transmit the formatted media production (shown as electronic show 2408) over, for example, the Internet or other computer mediums. Electronic show 2408 also is saved as archived show 2410. As previously discussed, post-production editing and approval application file 2409 is used to edit archived show 2410. Afterwards, archived show 2410 or portions thereof are available for future viewing as on-demand show 2414.

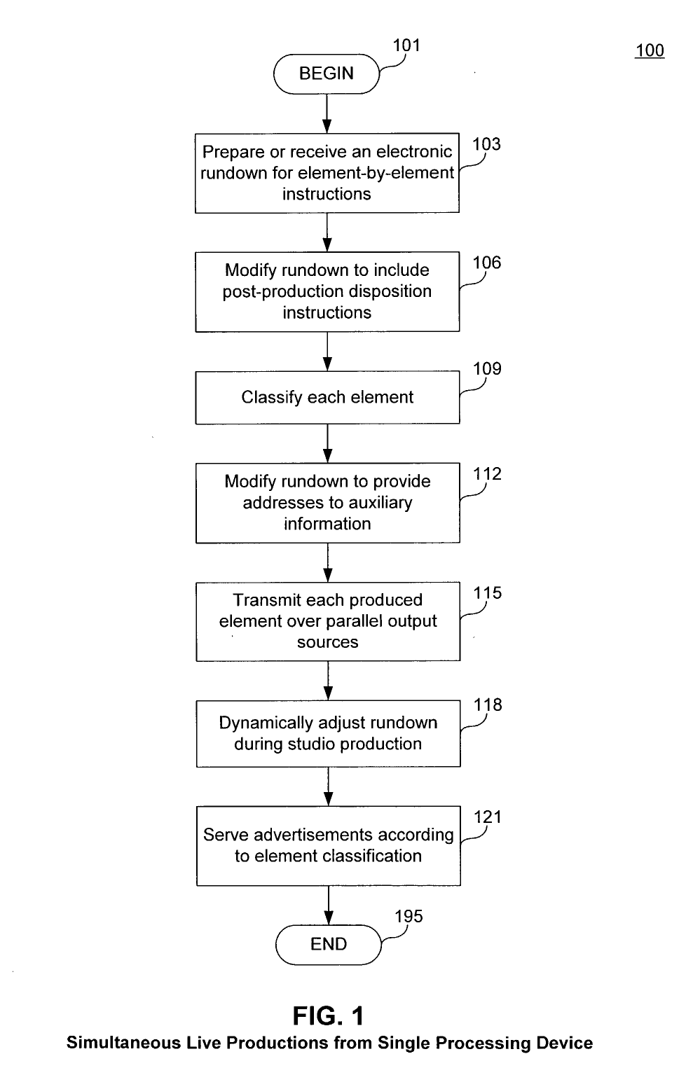

The present invention can be implemented in various configurations for producing and simultaneously transmitting via traditional distribution modes/methods and computer network transmissions. Referring to FIG. 1, flowchart 100 represents the general operational flow of an embodiment of the present invention. More specifically, flowchart 100 shows an example of a control flow for sending simulcasts from the same processing device according to the present invention. In other words, the processing device includes two video/audio output ports: one port to a master control for traditional distribution; and a second port for transmitting the output sources to an encoder that formats and transmits the media streams over a computer network. The processing device, thus, executes instructions to produce video for a show, and encode the video for transport over a computer network. It is noted that this implementation represents only an example embodiment of the present invention. Other implementations will be apparent to one skilled in the relevant art(s) based on the herein teachings.

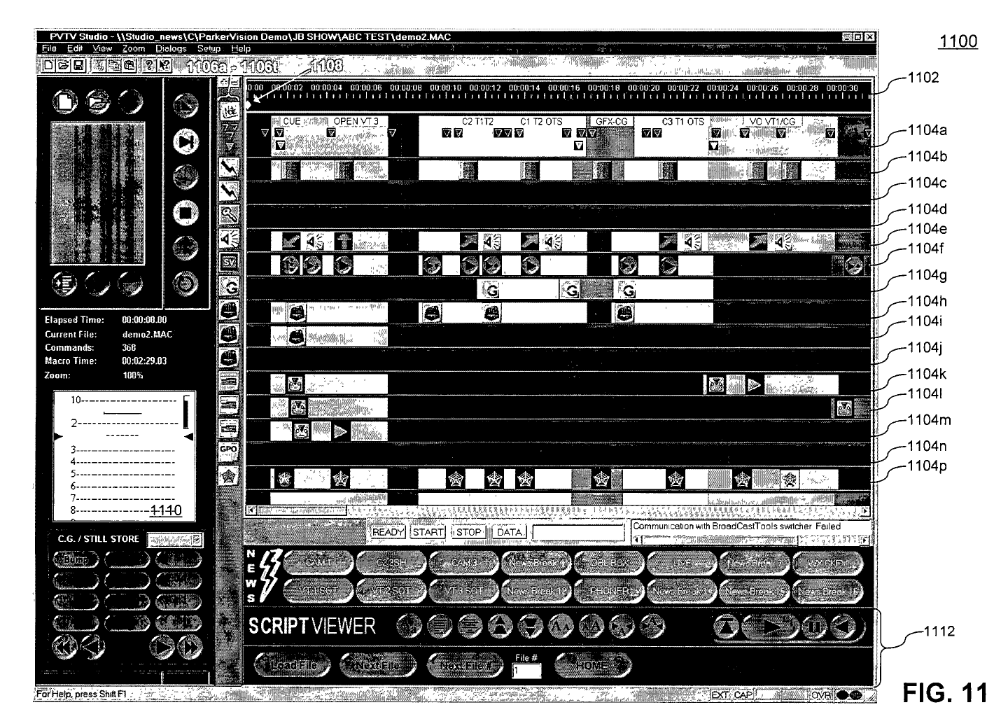

The control flow of flowchart 100 begins at step 101 and passes immediately to step 103. At step 103, electronic show rundown 2402 is prepared to specify element-by-element instructions for producing a live or non-live show. As discussed, the show's director may prepare show rundown 2402. However, electronic rundown 2402 of the present invention is often prepared by the show director, a web master, web cast director, or the like. Electronic rundown 2402 can be a text-based or an object-oriented listing of production commands. An exemplary embodiment of an electronic rundown is described in greater detail below with reference to FIG. 11, and it further described in the applications referred above.

When executed, electronic rundown 2402 is converted into computer readable broadcast instructions to automate the execution of a show without the need of an expensive production crew to control the media production devices. In an embodiment, the broadcast instructions are created from the Transition Macro™ multimedia production control program developed by ParkerVision, Inc. (Jacksonville, Fla.) that can be executed to control an automated multimedia production system. The Transition Macro™ program is described in the application entitled “System and Method for Real Time Video Production and Multicasting” (U.S. patent application Ser. No. 09/634,735), which is incorporated herein by reference as though set forth in its entirety. As described in the aforesaid application, the Transition Macro™ program is an event-driven application that allows serial and parallel processing of media production commands to automate the control of a multimedia production environment. Each media production command is associated with a timer value and at least one media production device.

At step 106, electronic rundown 2402 is modified to include instructions for post-production disposition of show elements. For instance, the director can “mark” an element on rundown 2402 to specify the beginning and/or the end of a story. The director can also mark or tag an element to be archived, encoded for transmission over a computer network, both, or neither. Techniques and methodologies for “marking” rundown 2402, or the like, are described in greater detail below with reference to FIGS. 11-18.

At step 109, electronic rundown 2402 is marked or edited to classify elements. In an embodiment, each element is given a major and minor classification. For example, an element of a newscast may be assigned to a major classification such as local sports, and a minor classification such as high school football.

At step 112, auxiliary information is associated with one or more elements listed on electronic rundown 2402. Electronic rundown 2402 is marked or edited to provide an address to the auxiliary information, or some other indication of the auxiliary information (including inserting the information itself), such that the auxiliary information can be presented with its associated element or requested by an on-line user during the element's presentation. For example, a media production is enhanced by associating related stories, related web sites, advertisement banners, flash media, script for the currently presented element, or the like. If a story comprises multiple elements, the auxiliary information can be associated at an element or story level, as determined by the director or other responsible crew member.

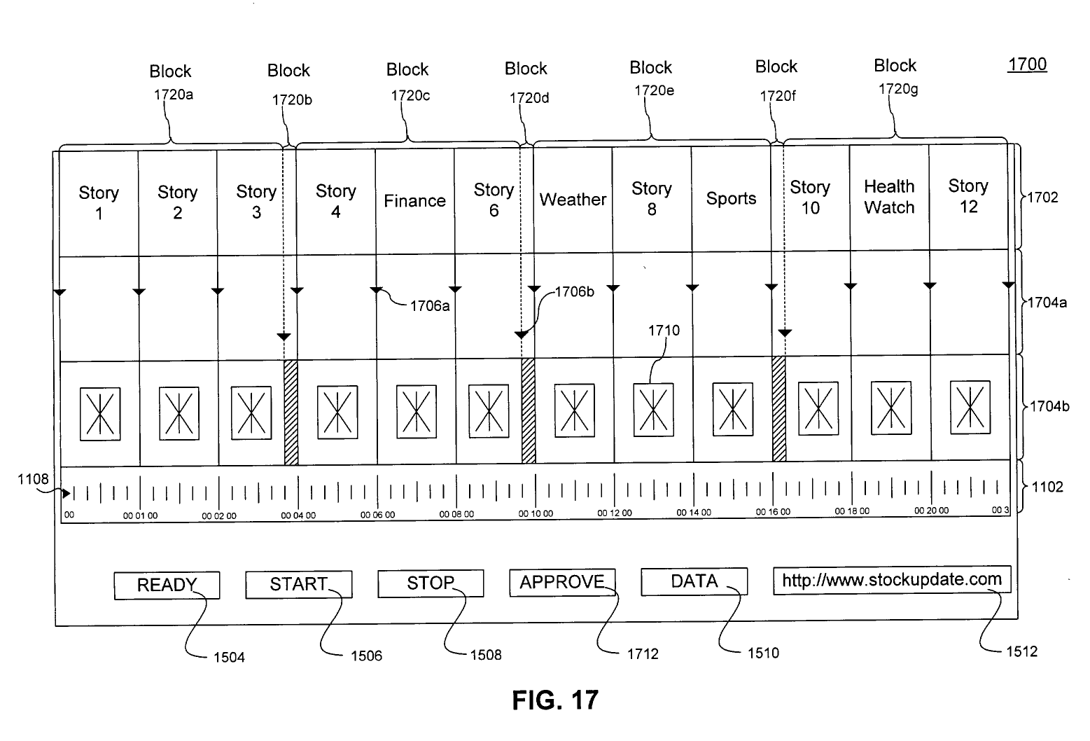

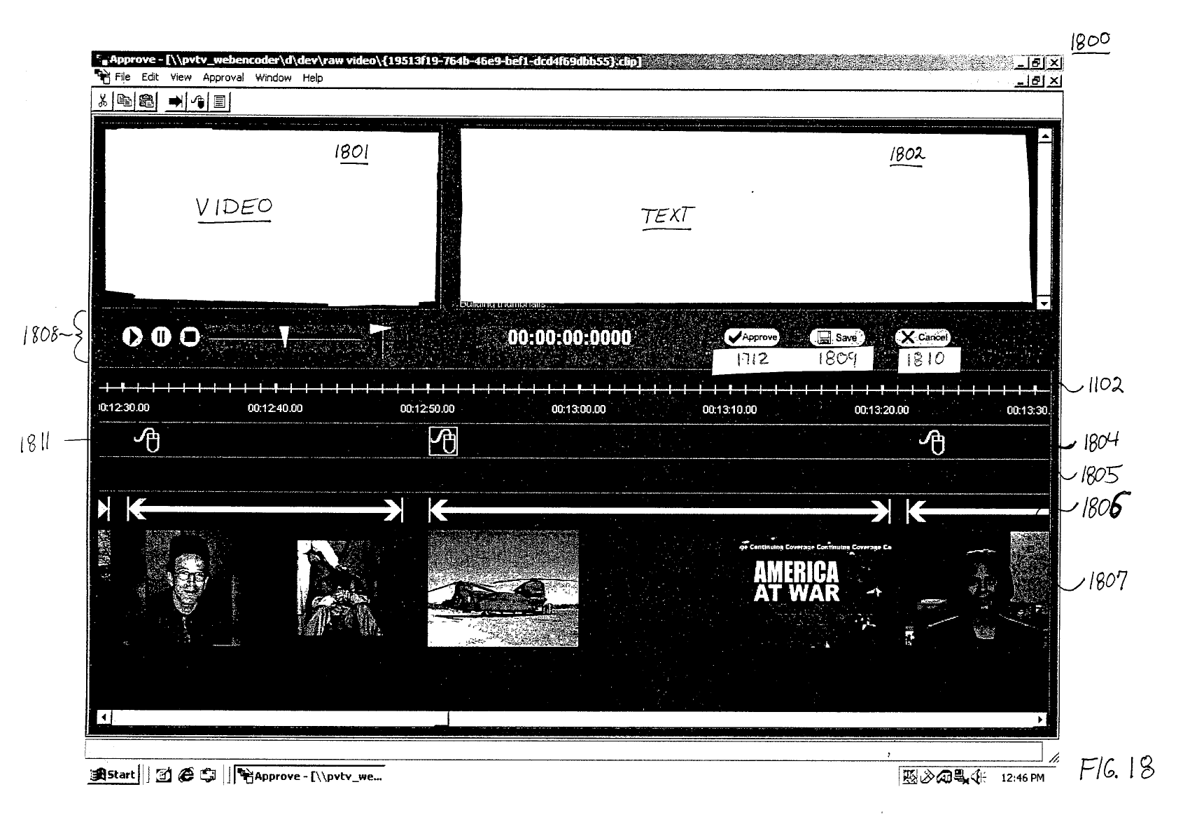

At step 115, the director executes electronic rundown 2402 to produce the show. The markings (for post-production disposition) are likewise executed in real time as an associated element is produced. As described in detail below with reference to FIGS. 17-18, the instructions from the markings are later used in post-production editing and approval application file 2409 to edit (if necessary), prepare, and archive individual stories (e.g., segments 2412a-2412x) for “on-demand” retrieval in whatever order a user prefers.

Referring back to step 115, each produced element is simultaneously transmitted according to rundown 2402 over parallel output ports. Hence, the media stream is split for the appropriate port. One media stream is transmitted from an output port to a master control system for a traditional distribution, as traditional show 2406. A second media stream is transmitted to the encoder, compressed and formatted for network transmissions, and forwarded through a second port over a computer network (e.g., the Internet or other computer medium), as electronic show 2408. Other operations are possible. For example, the stream can be transmitted over traditional mediums (as traditional show 2406), and prepared for later transmission over a communication network (as electronic show 2408). In this example, the media stream could be transmitted digitally either over traditional broadcast licensed RF spectrum, or via digital cable, satellite DBS, microwave, or other licensed or unlicensed wireless radio frequency air interface technology spectrum, directly to a consumer's digital set-top box or digital television set or other digital appliance. Alternatively, the broadcast can be transmitted over a computer network (as electronic show 2408), but not transmitted over traditional mediums (as traditional show 2406). Any combination of operations is within the scope of the present invention.

At step 118, the director is able to dynamically adjust, during production, electronic rundown 2402 to account for any changes in the live studio production. During a live broadcast, many unforeseeable events can occur that influences the production. Equipment can fail, talent may miss a cue, or breaking news may require real-time insertion. The present invention enables the director to revise electronic rundown 2402, during the production, to account for these occurrences.

At step 121, advertising is served during the commercial breaks of electronic show 2408 by the “commercial insertion application” (CIA) software according to an ad traffic scheduler that defines ad placement by show and show break block “A”, “B”, “C”, “D”, etc. for video based streaming ads. The over-the-air broadcast ads are served the traditional method from a commercial insertion system through master control. Video streaming ads may be the same or different compared to the over-the-air broadcast ads. Banner and button ads are served by the processing device and/or software according to element/story classifications (specified in step 109). As used herein, the term “advertisement” refers to any message designed to attract attention or patronage, and includes without limitation, paid advertisements, public service announcements, community notices, promotions, etc. For instance, a promotional or product advertisement is transmitted prior to or following an associated element/story. After the live production has been transmitted with the associated auxiliary information including advertisements, the control flow ends as indicated at step 195.

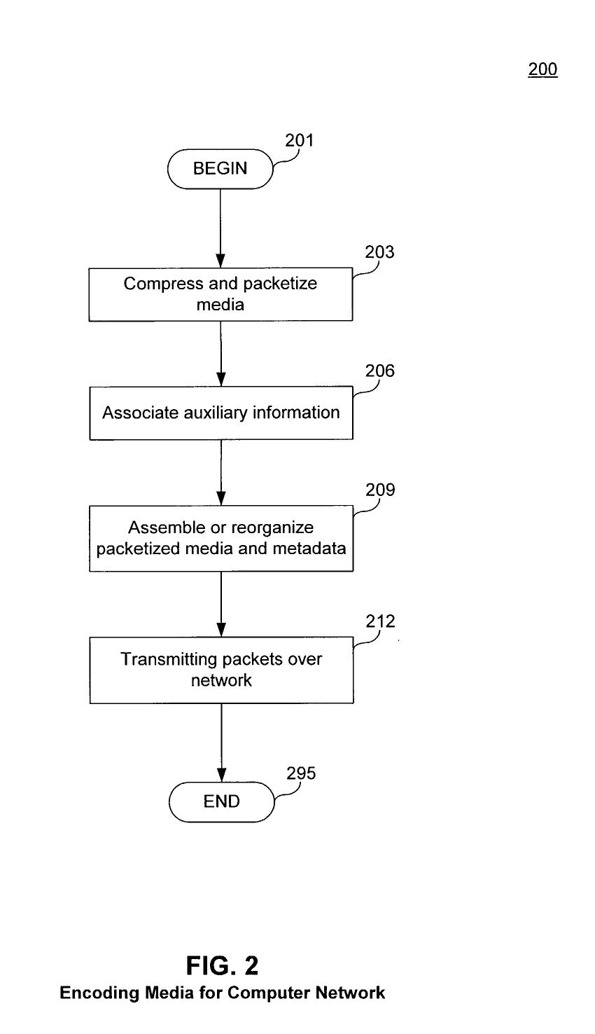

As discussed above with reference to step 115, the enhanced media production is delivered over a computer network to a display device. Prior to transmitting the media production, the enhanced media production is formatted for network transport. Referring to FIG. 2, flowchart 200 represents the general operational flow of an embodiment for formatting enhanced media productions. More specifically, flowchart 200 shows an example of a control flow for formatting media and associated metadata for webcasting.

The control flow of flowchart 200 begins at step 201 and passes immediately to step 203. At step 203, the media production (such as electronic show 2408) is compressed into packets. In an embodiment, the packets are formatted to support multimedia applications available from RealNetworks, Inc. (Seattle, Wash.), Microsoft Corporation (Redmond, Wash.), Apple Computer, Inc. (Cupertino, Calif.), or vendors of like applications as would be apparent to one skilled in the relevant art(s). In addition to the aforementioned proprietary formats, the media production formats can include, but are not limited to, MPEG-2 and MPEG-4 non-proprietary formats.

At step 206, metadata concerning any auxiliary information is integrated with the packets. As described, auxiliary information can be associated with one or more elements to enhance a media production. Thus, at step 206, the present invention ensures the association is preserved during the encoding process. In an embodiment, data frames containing the auxiliary information are formatted and concatenated to the media packets. Instructions are included to inform the client to display the auxiliary information with the associated elements. In another embodiment, addresses to the auxiliary information are added to the packets or a header. Accordingly, instructions are included to inform the client to request the associated auxiliary information for presentation.

For example, if a media production is formatted for Microsoft's Windows Media™ application, metafiles are prepared to serve as links from web pages to content formatted to support the Windows Media™ application. Hence, a metafile contains the URL of multimedia content on a server. A complex metafile contains multiple files or streams arranged in a playlist, instructions for playing the files or streams, text and graphic elements associated with the video and topic being streamed, hyperlinks associated with elements as they are displayed by a Windows Media™ application, or the like. As such, a metafile is prepared, in an embodiment, to include links and instructions for presenting auxiliary information with associated elements. In addition, show metadata (i.e., show name, date aired, etc.) is linked to each story so that a playlist can be generated, organized, and presented to the consumer either by show or by story classification. In addition, story metadata (i.e., story name, category, duration, and story association to show and air date) can also be illustrated for consumer identification, selection, and request.

At step 209, the packetized enhanced media and metadata are fragmented or concatenated based on available bandwidth and other network parameters. At step 212, the packets are transmitting over the network or any time of data processing communication medium to a client display device(s). After the production (i.e., electronic show 2408) has been transmitted with the associated auxiliary information, the control flow ends as indicated at step 295.

The embodiment described with reference to FIG. 1 is premised on the use of a single processing device that produces a live or non-live show and formats the show for a simultaneous traditional distribution (e.g., traditional show 2406) and web cast (e.g., electronic show 2408). Thus, the single processing device enables automated or semi-automated multimedia productions. However, the present invention can also be implemented in various configurations that do not utilize a processing device to automate a production. For instance, the present invention also supports synchronized parallel live or non-live productions in a manual or semi-automated multimedia production environment. As such, a web director or like crew member is able to duplicate the operations of a show director while the show director steps through all or part of a production. This process is referred to as newscast “shadowing.”

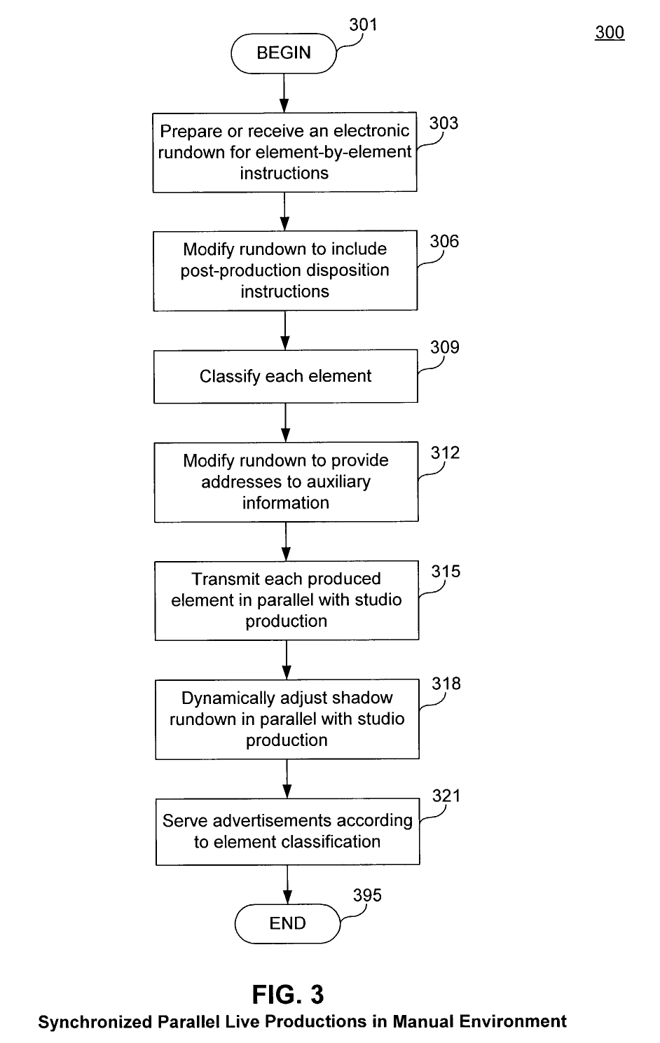

Referring to FIG. 3, flowchart 300 represents the general operational flow of an embodiment of the present invention for production shadowing. More specifically, flowchart 300 shows an example of a control flow for sending a media production (e.g., electronic show 2408) over a computer network. The media production is created in a manual or semi-automated studio environment, and broadcast (e.g., traditional show 2406) over television airwaves or other traditional mediums and/or modes. A processing device and/or software program is used to “shadow” the production for purposes of distribution (e.g., electronic show 2408) over a computer network, where such distribution is performed in a simulcast mode and/or an on-demand mode. In particular, a processing device and/or software program is provided to receive a feed of the production, and to encode and transmit the media over a computer network.

The control flow of flowchart 300 begins at step 301 and passes immediately to step 303. At step 303, show rundown 2402 is prepared to specify the element-by-element instructions for producing a live or non-live show. Since, in this embodiment, it is being used in manual or semi-automated environment, show rundown 2402 can be a paper or electronic embodiment. A shadow electronic rundown 2404 is prepared from show rundown 2402. Shadow electronic rundown 2404 can be a text-based or an object-oriented listing of production commands. However, unlike the show rundown 2402 at step 103, show electronic rundown 2402 and shadow electronic rundown 2402, in this embodiment, do not necessarily provide automated or semi-automated control of media production devices during the production. The show director and crew manually can control some or all production devices.

The shadow electronic rundown 2404, in this embodiment, includes instructions for formatting the production, such that it can be properly transmitted over a computer network. Thus, when executed, shadow electronic rundown 2404 is converted into computer readable broadcast instructions to automate the encoding process.

At step 306, shadow electronic rundown 2404 is modified to include instructions for post-production disposition of each show element. For instance, a web director can specify that an element be archived, encoded for transmission over a computer network, both, or neither. At step 309, shadow electronic rundown 2404 is edited to classify elements. In an embodiment, each element is given a major and minor classification.

At step 312, auxiliary information is associated with one or more elements listed on shadow electronic rundown 2404. Shadow electronic rundown 2404 is edited to provide an address or other instructions to the auxiliary information, such that the information can be presented with the element or requested by an on-line user during the element's presentation.

At step 315, the web director executes shadow electronic rundown 2404 to encode and produce the show (e.g., electronic show 2408) for transmission over the computer network. Hence, while the manual production is being transmitted to a master control system for a traditional distribution (e.g., traditional show 2406), the encoded media stream is being formatted for network transmissions (e.g., electronic show 2408) and forwarded through an output port over, for example, the Internet or other computer mediums.

At step 318, the web director is able to dynamically adjust shadow electronic rundown 2404 during the production to account for any changes made by the show director in show rundown 2402 for the studio production, as described above with reference to step 118 in FIG. 1. At step 321, advertising is served during the commercial breaks in electronic show 2408 by the “commercial insertion application” (CIA) software according to an ad traffic scheduler that defines ad placement by show and show break block “A”, “B”, “C”, “D”, etc. for video based streaming ads. Banner and button ads are served by the processing device and/or software according to element/story classifications. After the production has been transmitted with the associated auxiliary information, the control flow ends as indicated at step 395.

In another embodiment, the present invention can be implemented in various configurations that utilizes two or more processing devices. One processing device (or set of processing devices) is operable to encode a media production (e.g., electronic show 2408) for distribution over a computer network. The second processing device (or another set of processing devices) is operable to support the actual media production (e.g., traditional show 2406) that is broadcast over airwaves or other traditional mediums and/or modes.

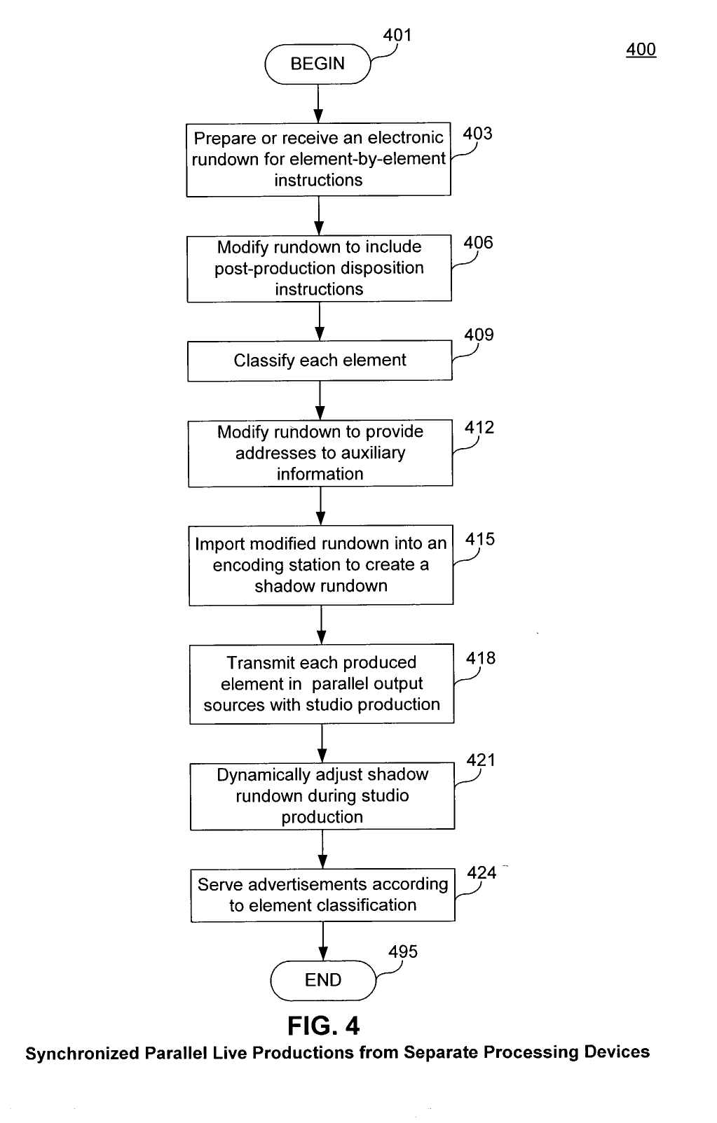

Referring to FIG. 4, flowchart 400 represents the general operational flow of an embodiment of the present invention for production shadowing. More specifically, flowchart 400 shows an example of a control flow for sending a live or non-live media production (e.g., electronic show 2408) over a computer network. In this embodiment, the media production is created in either a manual studio environment, or an automated multimedia production environment (e.g., using the PVTV Production Automation System available from ParkerVision, Inc.). Subsequently, the media production is broadcast (e.g., traditional show 2406) over television airwaves or other traditional mediums (such as cable, satellite, etc.). A dedicated processing device is operable to receive an electronic version (e.g., shadow rundown 2404) of the director's rundown (e.g., show rundown 2402), and a feed of the production (e.g., traditional show 2406). The production is, thereafter, encoded and transmitted (e.g., electronic show 2408) over a computer network (as noted above, such operation is called “shadowing”).

The control flow of flowchart 400 begins at step 401 and passes immediately to step 403. At step 403, an electronic show rundown 2402 is prepared to specify the element-by-element instructions for producing a live or non-live show. As described at step 103 in FIG. 1, electronic rundown 2402 can be a text-based or an object-oriented listing of production commands. If using an automated media production system, electronic rundown 2402 provides automated or semi-automated control of media production devices during the live production. However, if a manual production system is being used, the show director and crew manually control all production devices. As such in a manual environment, electronic rundown 2402 is a non-functional listing of production commands. For example, a news automation system can be used to develop an electronic rundown sheet of non-functional data. Such news automation systems are available from iNEWS™ (i.e., the iNEWS™ news service available on the iNews.com web site), Newsmaker, Comprompter, and the Associated Press (AP).

At step 406, electronic rundown 2402 is modified to include instructions for post-production disposition of show elements. For instance, the director can specify that an element be archived, encoded for transmission over a computer network, both, or neither. At step 409, electronic rundown 2402 is edited to classify elements. In an embodiment, each element is given a major and minor classification.

At step 412, auxiliary information is associated with one or more elements listed on electronic rundown 2402. Electronic rundown 2402 is edited to provide an address to, or other indication of, the auxiliary information, such that the information can be presented with the element or requested by an on-line user during the element's presentation.

At step 415, electronic rundown 2402 is imported into an encoding processing station that is used to create shadow rundown 2404. Shadow rundown 2404 includes instructions for formatting the production (e.g., electronic show 2408), such that it can be properly transmitted over a computer network.

At step 418, the web director executes shadow rundown 2404 to encode and produce the show (e.g., electronic show 2408) for transmission over the computer network. Hence, while the manual or automated production is being transmitted to a master control system for a traditional distribution (e.g., traditional show 2406), the encoded media stream is being formatted for network transmissions (e.g., electronic show 2408) and forwarded through an output port over, for example, the Internet or other computer medium.

At step 421, the web director is able to dynamically adjust, during production, shadow rundown 2404 to account for any changes made by the show director in the studio production, as described above with reference to step 118 in FIG. 1. At step 424, advertising is served during the commercial breaks by the “commercial insertion application” (CIA) software according to an ad traffic scheduler that defines ad placement by show and show break block “A”, “B”, “C”, “D”, etc. for video based streaming ads. Banner and button ads are served by the processing device and/or software according to element/story classifications. After the production has been transmitted with the associated auxiliary information, the control flow ends as indicated at step 495.

In the above embodiment described with reference to FIG. 4, an electronic rundown 2402 is prepared and modified to include encoding instructions. Afterwards, electronic rundown 2402 is imported into an encoding processing device(s) that creates, or otherwise provides, shadow rundown 2404 for execution. In another embodiment involving two or more processing devices, electronic rundown 2402 does not include any encoding instructions. Encoding instructions are included after electronic rundown 2402 is imported into the encoding processing device(s) to create shadow rundown 2404.

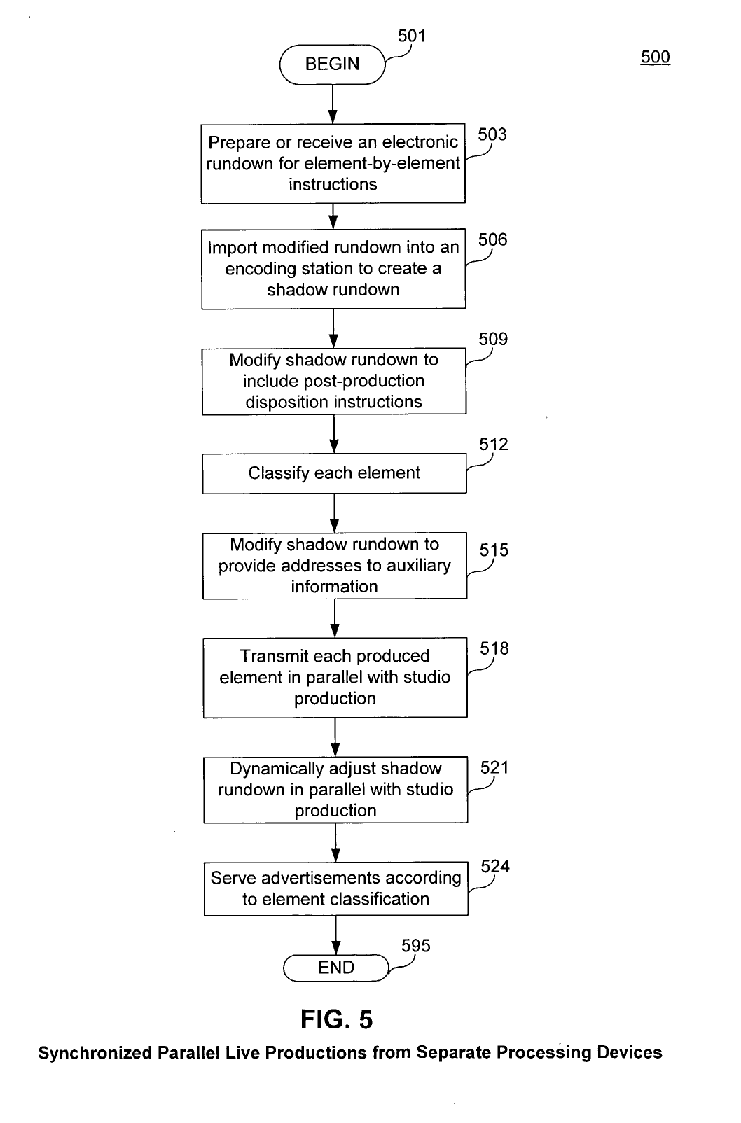

Referring to FIG. 5, flowchart 500 represents the general operational flow of another embodiment of the present invention for production shadowing. More specifically, flowchart 500 shows an example of a control flow for sending a live or non-live media production (e.g., electronic show 2408) over a computer network. In this embodiment, the media production is created in either a manual studio environment, or an automated multimedia production environment. Subsequently, the media production is broadcast (e.g., traditional show 2406) over television airwaves or other traditional mediums and/or modes. A dedicated processing device is operable to receive an electronic version of the director's rundown (i.e., show rundown 2402), and a feed of the live production. The production is, thereafter, encoded and transmitted over a computer network.

The control flow of flowchart 500 begins at step 501 and passes immediately to step 503. At step 503, an electronic show rundown 2402 is prepared to specify the element-by-element instructions for producing a live or non-live show. As described at step 403 in FIG. 4, electronic rundown 2402 can be a text-based or an object-oriented listing of production commands. If using an automated media production system, electronic rundown 2402 provides automated or semi-automated control of media production devices during the production. However, if a manual production system is being used, the show director and crew manually control all production devices. Therefore in manual environments, electronic rundown 2402 is a non-functional listing of production commands, and can be prepared with the aid of a news automation system. However, unlike step 403, electronic rundown 2402 is not modified at step 503 to include any post-production disposition instructions.

Instead, at step 506, electronic rundown 2402 is imported into an encoding processing station that is used to create a shadow rundown 2404. At step 509, shadow rundown 2404 is modified to include instructions for post-production disposition of show elements. At step 512, shadow rundown 2404 is edited to classify elements as previously described.

At step 515, auxiliary information is associated with one or more elements listed on shadow rundown 2404. Shadow rundown 2404 is edited to provide an address to, or other indication of, the auxiliary information, such that the information can be presented with the element or requested by an on-line user during the element's presentation.

At step 518, the web director executes shadow rundown 2404 to encode and produce the show (e.g., electronic show 2408) for transmission over the computer network. Hence, while the manual or automated production is being transmitted to a master control system for a traditional distribution (e.g., traditional show 2406), the encoded media stream is being formatted for network transmissions and forwarded through an output port over, for example, the Internet.

At step 521, the web director is able to dynamically adjust, during the production, shadow rundown 2404 to account for any changes made by the show director in the studio production, as described above with reference to step 118 in FIG. 1. At step 524, advertising is served during the commercial breaks by the “commercial insertion application” (CIA) software according to an ad traffic scheduler that defines ad placement by show and show break block “A”, “B”, “C”, “D”, etc. for video based streaming ads. Banner and button ads are served by the processing device and/or software according to element/story classifications. After the production has been transmitted with the associated auxiliary information, the control flow ends as indicated at step 595.

III. Post-Production Disposition

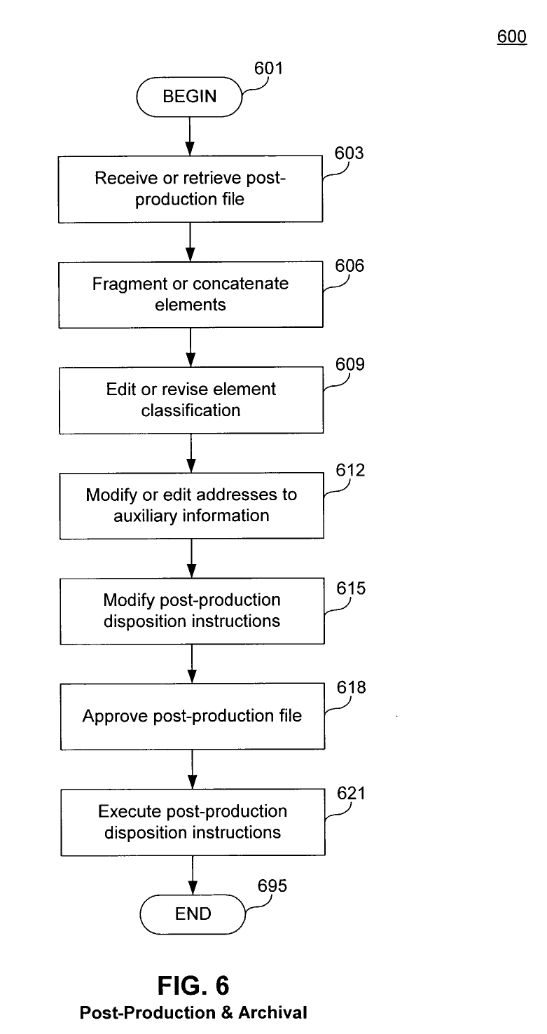

After a live or non-live show has been produced and distributed (e.g., traditional show 2406 and/or electronic show 2408) as described above, an embodiment of the present invention provides a system, method, and computer program product for editing and archiving the post-production show (e.g., archived show 2410). Referring to FIG. 6, flowchart 600 represents the general operational flow of an embodiment of the present invention. More specifically, flowchart 600 shows an example of a control flow for implementing post-production instructions for a media production. It is noted that, while flowchart 600 can operate with a show produced as described above, flowchart 600 is also operable with shows produced from other sources and/or using other techniques.

The control flow of flowchart 600 begins at step 601 and passes immediately to step 603. At step 603, a post-production editing and approval application file 2409 is received or retrieved from a storage location. Post-production editing and application file 2409 is derived, or otherwise provided, from the execution of the show while synchronizing metadata and auxiliary information with the video and audio output. The element definitions, metadata, and auxiliary information are derived from the electronic rundown 2402 or shadow rundown 2404 whose encoding instructions have been executed in accordance with FIGS. 1-5, above, or through some other source and/or means. In an embodiment, post-production editing and approval application file 2409 is processed using an object-oriented user interface that provides an interactive display. An exemplary embodiment of post-production editing and approval application file 2409 is described in greater detail below.

At step 606, a web director interacts with post-production editing and approval application file 2409 to edit or modify elements from the media production (e.g., traditional show 2406 and/or electronic show 2408). The media production is stored to a storage medium as archived show 2410, and post-production editing and approval application file 2409 enables the web director to edit or modify archived show 2410. Post-production editing and approval application file 2409 can be modified to change beginning and end points of a specific story. Post-production editing and approval application file 2409 can also be modified to delete or cut the elements/stories. Elements/stories of the show can be cut or fragmented by using the fragmentation process, discussed in detail below with reference to FIGS. 17-19. Post-production editing and approval application file 2409 can also be modified to concatenate elements into a single unit or video clip.

At step 609, the web director interacts with post-production editing and approval application file 2409 to make edits or revisions to the current classification of an element. The web director can change or provide a major or minor classification.

At step 612, post-production editing and approval application file 2409 is updated to edit or modify the addresses to, or other indication of, auxiliary information associated with each element. Post-production editing and approval application file 2409 can also be altered to associate new or different auxiliary information. For example, post-production editing and approval application file 2409 can be modified to add metadata and auxiliary information for data window display (such as URLs that include HTML pages with data, graphics, text, photos, video, and animation in addition to related story and/or extended play segment URLs, and web site reference URLs). Post-production editing and approval application file 2409 can also be modified to add script to facilitate captioning and/or the provisioning of complete transcripts.

At step 615, the post-production disposition instructions can be reviewed and altered. Elements previously tagged for archive can be deleted, or vice versa.

At step 618, the “updated” post-production editing and approval application file 2409 is approved by the web director, and at step 621, post-production editing and approval application file 2409 is executed to implement the post-production disposition instructions. As the post-production disposition instructions are executed, archived show 2410 is appropriately modified in accordance with the instructions. The resulting archived show 2410 is stored to a storage medium for future recall. As shown in FIG. 24, archive show 2410 can be stored as multiple segments 2412a-2412x. A segment 2412a-2412x can represent one or multiple elements or one or more stories, as determined by the web director. Referring back to FIG. 6, upon execution of the post-disposition instructions, the control flow ends as indicated at step 695.

IV. Benefit of Invention Using an Example Web Cast

In an embodiment of the present invention, an on-line user can visit a portal or web site that is hosted by an entity or individual having produced and/or archived content according to the present invention, or an entity or individual associated with or having access to such content. As such, hosting facilities provide portals for visitors to receive a live or customized program on demand. The hosting facilities can be operated by a local television, radio station, newspaper, webcasting station, or like media “hosting” environment.

As an example implementation of the present invention, a thirty minute news program is produced and broken up into separate topics, including national news, local news, sports, weather, business, and the like. These news topics are segmented and appropriately categorized (e.g., sports can be categorized to football or Jacksonville Jaguars). An index is then established using these categories so that individuals can easily query the index and select the news segments they want to view. The selection index can be organized by show (with categories underneath with stories to that specific show), category (lists all stories within each category for multiple shows), or a keyword search can be performed. Alternatively, the user can set up a template (user profile) so that a news program is automatically generated based on personal preference. The profile is maintained in a database so that upon login by the user, a “personalized newscast” can be downloaded without the user having to assemble it. Without a profile, the user will have to build their personalized show each time upon login. The information gathered from the profile can also be used to sell targeted ads. The user can modify their profile at any time to change their preferences. Once the profile is set, the user upon login can play it as is, modify their personalized newscast, or build a new personalized newscast from scratch (as if they did not enter a profile). The news program is then compiled, potentially with advertisements, and downloaded to the user's display device in real time or near term.

As described, an embodiment of the present invention enables a visitor to interact with a web site and select enhanced media content to be displayed on a display device. The browser for the display device directs media streams to a viewer launched by the display device. In an embodiment, the visitor builds a show via the viewer which, in turn, sends a request for a metafile. The metafile is a list of all of the files/stories requested, including video advertisements. Show segments assembled and requested by the viewer are sent to a server. The viewer gets back an ASX play list that includes, for example, an introduction video, advertisement videos and story videos. The ASX file plays the multiple WMV files or like formats. Each file represents a story or segment that contains all content and associated links.

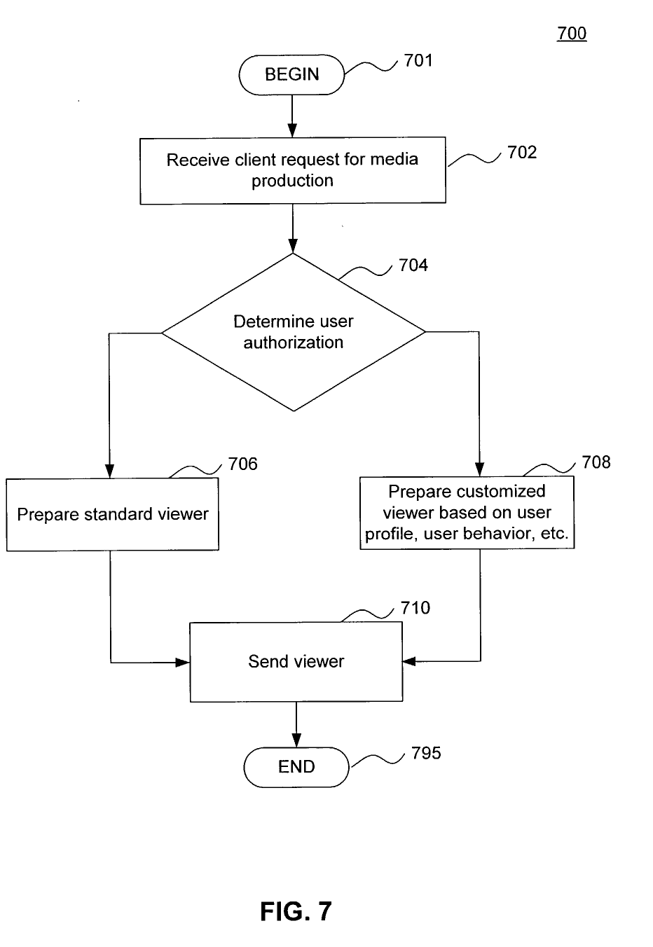

Referring to FIG. 7, flowchart 700 represents the general operational flow of an embodiment of the present invention. More specifically, flowchart 700 shows an example of a control flow for providing an enhanced media viewer according to the present invention.

The control flow of flowchart 700 begins at step 701 and passes immediately to step 702. At step 702, an on-line user operates a display device to gain access to the portal of a media host. The portal's server delivers a web page (not shown) that provides various data disseminated by the media host. In an embodiment, an icon resides on the web page that allows the user to request a media production that is assembled according to the methods of the present invention. Activating the icon sends the request to the portal's server. As apparent to one skilled in the relevant art(s), other methods can be used to send a request to the portal's server for a media production, such as sending a URL address; activating hyperlinks, hypertext, or hot spots; or the like.

At step 704, the server analyzes the request to identify or authenticate the user. Usernames, password, user profiles, cookies, or similar identification methods can be used to identify the user. The first time a user sends a request for a media production (or if specified in the user profile), the control flow passes to step 706. At step 706, the server prepares a standard viewer. The standard viewer includes a standardized listing of available media selections (e.g., news stories) displayed in a menu format.

If, however, the user has established a profile for customized programming, the control flow would pass from step 704 to step 708. At step 708, the server prepares a customized viewer that includes a customized listing of available media selections. The customized listing identifies, for example, news stories specified in the user profile. In an embodiment, the user registers and completes a profile that specifies preferred topics or categories of interest. The user can specify other parameters, such as the duration of a customized program, start or end time, geographic source of the content, or the like. In another embodiment, the present invention queries search engines, inference engines, profiling engines, or the like to extract user preferences from past behavior, psychographics, demographics, or the like.

At step 710, the server sends the viewer to be displayed by the user's display device. Notwithstanding the receipt of a standard or customized viewer, the user can opt to switch to a different viewer or change the customization parameters. Upon receipt of the viewer, the control flow ends as indicated at step 795.

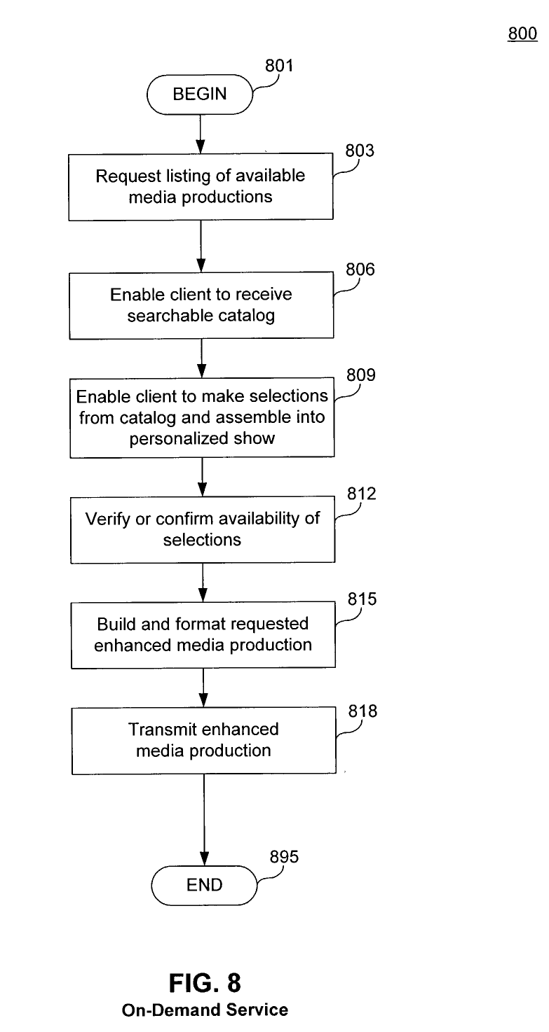

In an embodiment of the present invention, a portal visitor interacts with a standard or customized viewer to assemble and request a media production. The visitor's request can be based on the actual demands or behavioral patterns of the visitor. Referring to FIG. 8, flowchart 800 represents the general operational flow of an embodiment of the present invention. More specifically, flowchart 800 shows an example of a control flow for producing and distributing enhanced media according to the present invention.

The control flow of flowchart 800 begins at step 801 and passes immediately to step 803. At step 803, a visitor logs onto a web site operated by a media host. The visitor's display device sends a request for a list of available media productions. The host's server extracts metadata (including filename and URL addresses) from post-production disposition instructions, and/or provide a searchable catalog that is transmitted to the display device. The catalog lists the available media productions at the story or, if applicable, element level.

At step 806, the display device receives and displays the searchable catalog. In an embodiment, the visitor's display device receives or launches a standard or customized viewer as described in steps 701-795 of FIG. 7. The visitor is able to view, for example, the news stories displayed in the standard or customized listing.

At step 809, the visitor interacts with the display device to select one or more stories or story elements or other content from the catalog, and assemble the selection into a personalized show. The visitor can request to view all or a subset of the catalog listing in any order. The visitor operates the display device to send the selection request to the server, and the request is forwarded back to the server.

At step 812, the server verifies or confirms the availability and location of the selections. Subsequently, at step 815, the server retrieves, assembles, and encodes the selections for transmission. During this process, the server integrates various auxiliary information into the media stream with the news stories. In an embodiment, the server updates or changes the auxiliary information associated with the requested media. As described, the auxiliary information includes extended play video, related web sites, supporting graphics, scripts, keyers, special effects, or the like. Additionally, the server links national or local advertisements with the media streams. The advertisements include active banners, pre-roll commercials, email correspondence, or similar promotions.

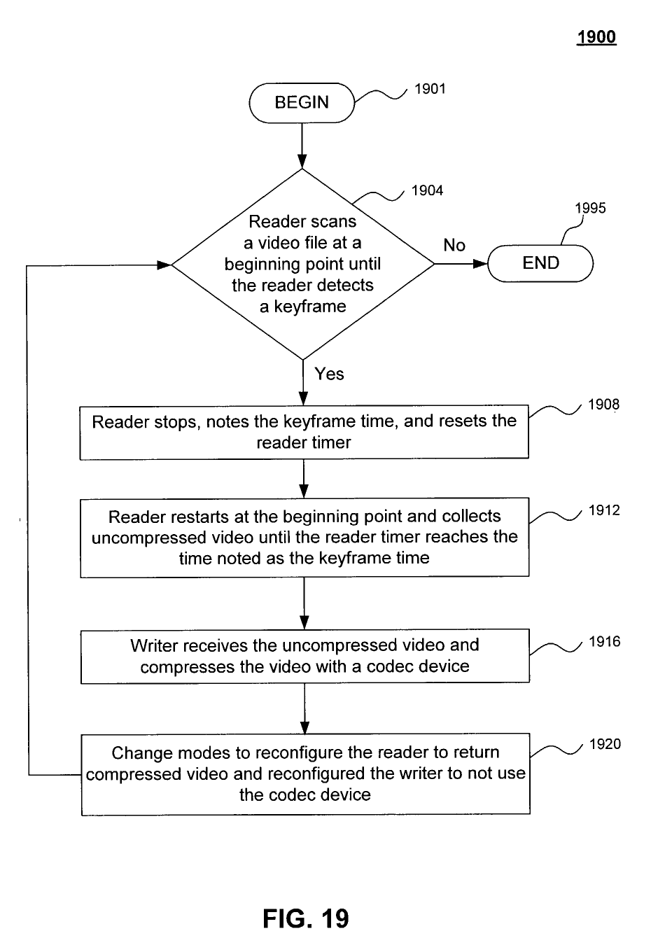

At step 818, the requested media production, including associated auxiliary information, is transmitted to the visitor's display device. In an embodiment, the enhanced media production is continuously fed to the display device to produce a seamless or near seamless display. Although the visitor operating the display device only experiences a single download, buffering process and playout, an embodiment of the present invention actually provides multiple files in the requested order to be played in a seamless or near seamless manner. This is achieved by the development of a video fragmentation technique, discussed in detail below with reference to FIG. 19. In other words, the server assembles an entire media production as requested by the visitor. The media production is fragmented such that a portion of the media production is sent downstream to the display device to be buffered for playout. As the buffer is emptied for display, an additional media stream is sent to the buffer such that the display device is creating a seamless or near seamless display on its viewer.

However in another embodiment, the media production can be downloaded for delayed viewing. In another embodiment, the media production can be saved on a local memory of the display device for future viewing. Upon distribution of the requested media production, including associated auxiliary information, to the requesting display device, the control flow ends as indicated at step 895.

Accordingly, an embodiment of the present invention enables a portal's server to assemble and stream over the World Wide Web each customized program for each visitor, in real time or near term. From the visitor's perspective, the customized program appears seamless. The visitor is provided with the customized program as soon as the visitor indicates that the program is to start. The segments, which make up the customized program, are automatically sequenced together with the linked advertisements in such a fashion that the program appears to have been created for the visitor according to a subject matter specification indicated by the visitor.

Thus, an embodiment of the present invention permits a visitor to specify the desired content of a customized program by using subject matter specifications. These specifications define the desired subject matter, the geographical source of the subject matter, the creation time and date of the subject matter, when the program is to begin and how long it is to last, or other user defined parameters. A menu format can be used by the viewer launched by the display device to assist the visitor in defining the specifications. Alternately, the viewer can provide predefined specifications, or can allow the visitor to upload specifications generated by a program or database search engine.

In an embodiment, profiles are generated automatically or manually. An automatic profile allows the media host to accumulate demographics and metrics for the sale of advertising, and the definition and scheduling of programming. This is performed automatically by the use of cookies, or similar user identifiers, loaded onto a display device. Each time a media host's server is accessed, data is captured and stored to develop a profile of the visitor. Every time the same display device or visitor logs onto the server, the display device receives a customized preprogrammed show according to the visitor's profile. The visitor then has the ability to accept or reject the pre-defined customized show. A modified or a totally brand new show also can be requested and assembled. Alternatively, the present invention also allows a visitor to complete a visitor profile with more detailed information. In an embodiment, the present invention allows the broadcaster to offer an incentive and password protection for the purpose of obtaining profile data from the visitor.

Thus, the present invention provides a method, system, and computer program product for distributing enhanced media and advertisements over a widely distributed network in response to the actual demands and behavioral patterns of on-line users. The present invention permits advertisements to be linked to the enhanced media and presented to the users who are most likely to purchase the promoted item. The cost for such advertisements is based on the actual distribution to the user, (or alternatively, ads can be sold based on “time durations” similar to a traditional distribution model, or a combination of both), and the resulting revenue is apportioned according to various models, as described in the application entitled “Method, System and Computer Program Product for Producing and Distributing Enhanced Media Downstreams” (U.S. patent application Ser. No. 09/836,239), which is incorporated herein by reference as though set forth in its entirety.

The above reference to a news program is made for illustrative purposes only. The present invention is equally applicable to live and non-live productions of any type and subject, using, for example, live talent, animation, computer-generated characters, etc. As intimated above, the production is not limited to video or multimedia streams. The present invention also supports customizable productions of other types/forms of information, including for example, text, electronic messaging, advertisements, etc.

For example, the present invention can be configured to automatically compile a customized show related to traffic. This can be established to be sent in the mornings and afternoons to facilitate a user's commute. Such operation can be established to occur automatically via appropriate setting of preferences, or by sending an appropriate request. Other applications are also possible. For example, in the above, local weather stories can be sent to the user at predetermined times to assist with commute or travel. Restaurant and/or show reviews can be sent to the user on Friday evenings, for example (i.e., before the weekend). These and other calendar examples are shown in Table 1 below.

TABLE 1
Calendar Options

| Topic | Delivery Time |
|---|---|
| Information/stories related | 6 a.m. and 4 p.m. |
| to traffic and/or weather | |
| Information related to | 1 week before Thanksgiving |
| turkey dinners/recipes | and Christmas |
| Informational stories related | 2 weeks before kid's |
| to kid's parties and gifts | birthdays and Christmas |
| Information/stories related | Every Friday evening |
| to family activities | |
| Information/stories related | 1 hour before every game |
| to local teams (or specified | |
| teams) | |
| Software automatically | Daily |
| parses user's calendars to | |
| identify keywords (such as | |
| “New York”), and | |
| compile/deliver stories | |
| related to that keyword | |

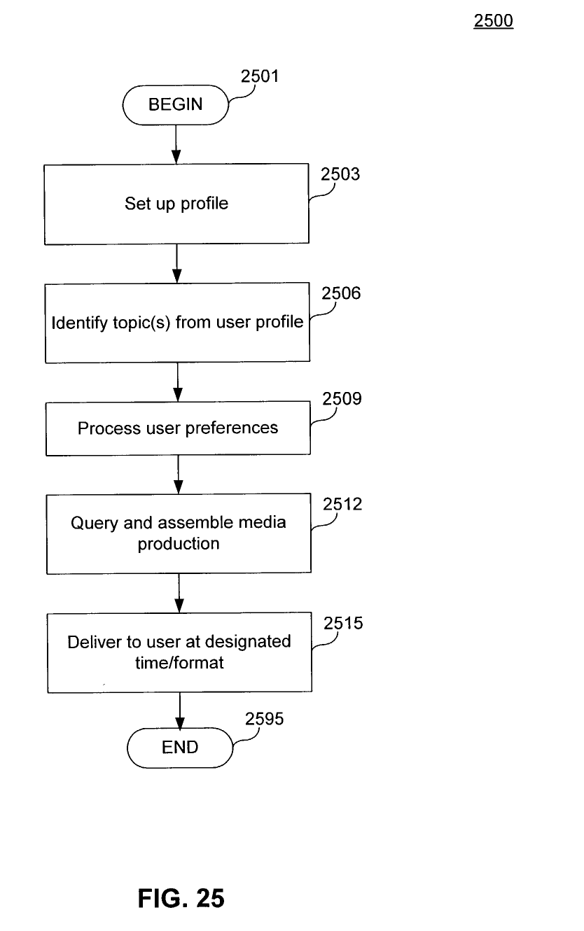

Table 1 lists several example implementations of the present invention. Each topic represents a customizable media presentation that a user has the option of selecting or defining. The delivery time stipulates when the user prefers to receive the media presentation. The above examples are further explained with reference to FIGS. 25-31.

First referring to FIG. 25, flowchart 2500 represents the general operational flow of an embodiment of the present invention. More specifically, flowchart 2500 shows an example of a control flow for customizing a production based on a calendar event, such as, but not limited to, the events shown in Table 1.

The control flow of flowchart 2500 begins at step 2501 and passes immediately to step 2503. At step 2503, a profile is established for the user. This can be accomplished via a registration process, an email request from the user, or any other well-known method for indicating a user's request/preference. As described above, the user specifically indicates one or more topics of interest, or a profiling engine or the like generates topic(s) based on demographic, psychographic, or behavioral patterns. However, in another embodiment, passive techniques are employed to generate the user's preferences by monitoring the user's Internet usage, mailing list memberships, e-commerce purchase history, or the like.

At step 2506, the user's profile is collected and analyzed to identify or select the topic(s) of interest, as specified in the user profile or determined by a profiling engine. At step 2509, the user's other preferences are considered. The user may indicate a preferred date or time to receive media content. The user may also indicate a preferred duration or file size. If the user has adequate storage capacity on the client display device, the user may specify file size. Other preferences can be indicated as stated above. For example, the user may specify certain formats for video (e.g., avi), text (e.g., html), audio (e.g., wav format), images (e.g., bmp), or the like.

At step 2512, the user's profile is executed to select media matching the user's interests. As described herein, the media includes video, text articles, web sites, merchandising, audio feeds, etc. The selected media is assembled and compiled for transmission.

At step 2515, the media production is transmitted to the user's client as described above. The media production is transmitted at the designated time and format specified by the user. After the customized media presentation has been transmitted, the control flow ends as indicated at step 2595.

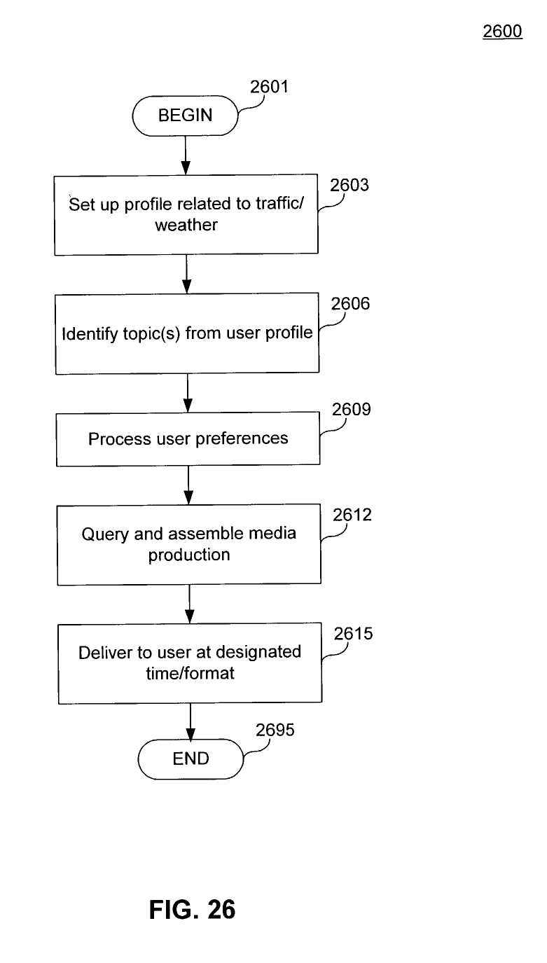

A second example of a control flow for customizing a production is shown in FIG. 26. Referring to FIG. 26, flowchart 2600 represents the general operational flow of another embodiment of the present invention. More specifically, flowchart 2600 shows an example of a control flow for customizing a production based on the first topic shown in Table 1.

The control flow of flowchart 2600 begins at step 2601 and passes immediately to step 2603. At step 2603, a profile is established for the user. Referring to the first topic in Table 1, the user actively requests topics related to traffic and/or weather. However, in another embodiment, passive techniques are employed to generate the user's preferences by monitoring the user's Internet usage, mailing list memberships, e-commerce purchase history, or the like. Referring back to the first example shown in Table 1, a profiling engine or the like would determine the user prefers topics related to traffic and/or weather.

At step 2606, the user's profile is collected and analyzed to identify or select the topic(s) of interest. In this case, the topic is traffic and/or weather, as specified in the user profile or determined by a profiling engine. At step 2609, the user's other preferences are considered. The user may indicate a preferred time to receive media content. Referring back to Table 1, in the first example, the user specifies 6 a.m. and 4 p.m. which correspond to the user's morning and evening commute.

The user may also indicate a preferred duration or file size. For example, if the commute is thirty minutes, the user may specify the compiled presentation to be less than twenty minutes. If the user has adequate storage capacity on the client display device, the user may specify file size. Other preferences can be indicated as stated above. For example, the user may specify certain formats for video (e.g., avi), text (e.g., html), audio (e.g., wav format), images (e.g., bmp), or the like.

At step 2612, the user's profile is executed to select media matching the user's interests. As described herein, the media includes video, text articles, web sites, merchandising, audio feeds, etc. The selected media is assembled and compiled for transmission.

At step 2615, the media production is transmitted to the user's client as described above. The media production is transmitted at the designated time and format specified by the user. In the first example shown in Table 1, the production is delivered at 6 a.m. and 4 p.m. After the customized media presentation has been transmitted, the control flow ends as indicated at step 2695.

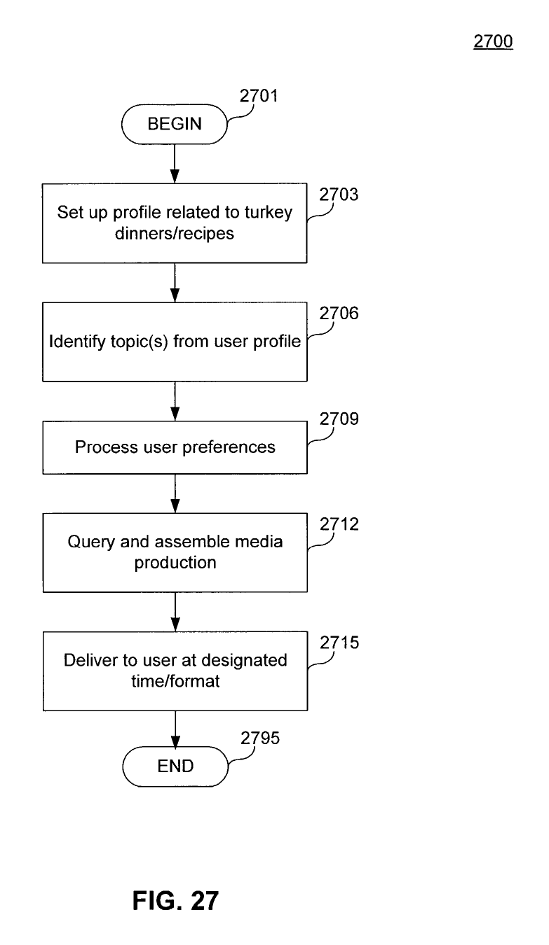

A third example of a control flow for customizing a production is shown in FIG. 27. Referring to FIG. 27, flowchart 2700 represents the general operational flow of another embodiment of the present invention. More specifically, flowchart 2700 shows an example of customizing a production based on the second topic shown in Table 1.

The control flow of flowchart 2700 begins at step 2701 and passes immediately to step 2703. At step 2703, a user profile is established to designate topics related to turkey dinners or recipes. As described above, the user can specifically indicate an interest in this topic to help plan for an upcoming event or holiday. The user may have so established this interest at an earlier date, such that the operation of the invention serves as a reminder to the user. Alternatively, an inference engine or the like can consider the user's demographic, psychographic, or behavioral patterns to infer an interest in this topic.

At step 2706, the user's profile is collected and analyzed to identify or select the topic(s) of interest. In this case, the topic is turkey dinners or recipes, as specified in the user profile or determined by an inference engine. At step 2709, the user's other preferences are considered. Referring back to Table 1, in the second example, the user specifies a preferred time for receiving the media content as being one week prior to Thanksgiving and Christmas.

As discussed, the user may also indicate a preferred duration or file size. For example, if requesting a collection of on-demand video of cooking programs, the user may specify the compiled production to average one hour. If the user has adequate storage capacity on the client display device, the user may specify file size. Other preferences can be indicated as stated above.

At step 2712, the user's profile is executed to select media matching the user's interests. As described herein, the media includes video, text articles, web sites, merchandising, audio feeds, etc. The selected media is assembled and compiled for transmission.

At step 2715, the media production is transmitted to the user's client as described above. The media production is transmitted at the designated time and format specified by the user. In the second example shown in Table 1, the production is delivered one week before Thanksgiving and Christmas. After the customized media presentation has been transmitted, the control flow ends as indicated at step 2795.

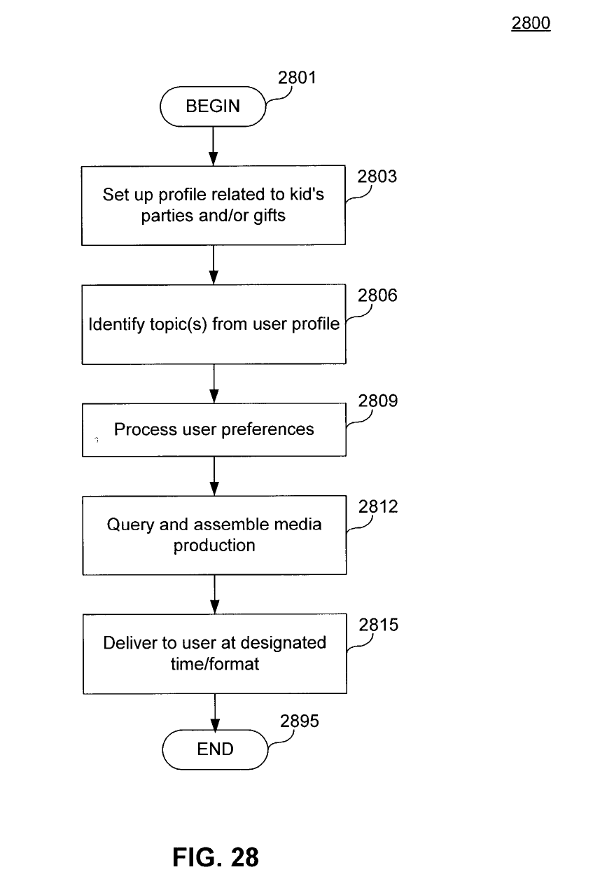

A fourth example of a control flow for customizing a production is shown in FIG. 28. Referring to FIG. 28, flowchart 2800 represents the general operational flow of another embodiment of the present invention. More specifically, flowchart 2800 shows an example of customizing a production based on the third topic shown in Table 1.

The control flow of flowchart 2800 begins at step 2801 and passes immediately to step 2803. At step 2803, a user profile is established to designate topics related to children parties and/or gifts. For example, a parent, school official, or other individual may have interests in planning an upcoming event for a child's birthday, recital, batmitzvah, or the like. The individual may be interested in gift ideas, decorations, hiring clowns, etc. As described above, the user can specifically indicate an interest in this topic, or an inference engine or the like can consider the user's demographic, psychographic, or behavioral patterns to infer an interest in this topic.

At step 2806, the user's profile is collected and analyzed to identify or select the topic(s) of interest. In this case, the topic is parties and/or gifts for children, as specified in the user profile or determined by an inference engine. At step 2809, the user's other preferences are considered. Referring back to Table 1, in the third example, the user specifies a preferred time for receiving the media content as being two weeks prior to a child's birthday and Christmas. If using the present invention for multiple children, the user would designate the birthday for each child. The user can also tailor the profile for the specific interests, preferences, age, gender, or the like, for each child. For example, one child may prefer video games, a second child may prefer musical instruments, a third child may prefer nineteenth century American literature, a fourth child may prefer camping or gaming, etc.

As discussed, the user may also indicate a preferred duration or file size. Other preferences can be indicated as stated above.

At step 2812, the user's profile is executed to select media matching the user's interests. As described herein, the media includes video, text articles, web sites, merchandising, audio feeds, etc. The selected media is assembled and compiled for transmission.

At step 2815, the media production is transmitted to the user's client as described above. The media production is transmitted at the designated time and format specified by the user. In the third example shown in Table 1, the production is delivered two weeks before a child's birthday and Christmas. After the customized media presentation has been transmitted, the control flow ends as indicated at step 2895.

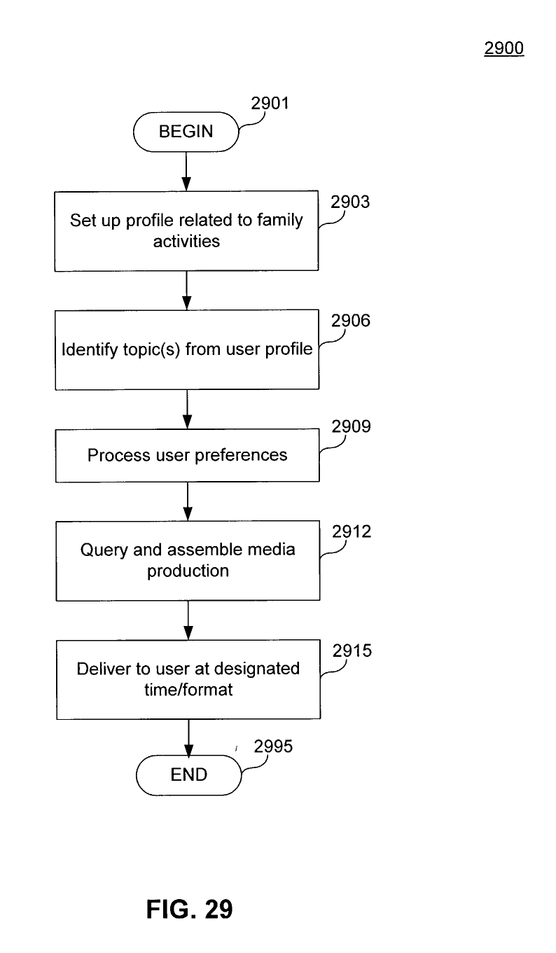

A fifth example of a control flow for customizing a production is shown in FIG. 29. Referring to FIG. 29, flowchart 2900 represents the general operational flow of another embodiment of the present invention. More specifically, flowchart 2900 shows an example of customizing a production based on the fourth topic shown in Table 1.

The control flow of flowchart 2900 begins at step 2901 and passes immediately to step 2903. At step 2903, a user profile is established to designate topics related to family activities. As described above, the user can specifically indicate an interest in this topic so that the present invention can be implemented to help plan for future events and/or activities. Alternatively, an inference engine or the like can consider the user's demographic, psychographic, or behavioral patterns to infer an interest in this topic.

At step 2906, the user's profile is collected and analyzed to identify or select the topic(s) of interest. In this case, the topic is family activities, as specified in the user profile or determined by an inference engine. At step 2909, the user's other preferences are considered. Referring back to Table 1, in the fourth example, the user specifies a preferred time for receiving the media content as being every Friday evening.

As discussed, the user may also indicate a preferred duration, file size or other preferences, as stated above. For example, if the user has expressed an interest in receiving on-demand video of movies or television programs, the user can set limitations on the length of the movie or rating time (e.g., G, PG-13, R, etc.). The user can request the video to be downloaded to a storage device for family viewing. For example, the user may specify certain formats for video (e.g., avi), text (e.g., html), audio (e.g., wav format), images (e.g., bmp), or the like.

At step 2912, the user's profile is executed to select media matching the user's interests. As described herein, the media includes video, text articles, web sites, merchandising, audio feeds, etc. The selected media is assembled and compiled for transmission.

At step 2915, the media production is transmitted to the user's client as described above. The media production is transmitted at the designated time and format specified by the user. In the fourth example shown in Table 1, the production is delivered every Friday evening. After the customized media presentation has been transmitted, the control flow ends as indicated at step 2995.

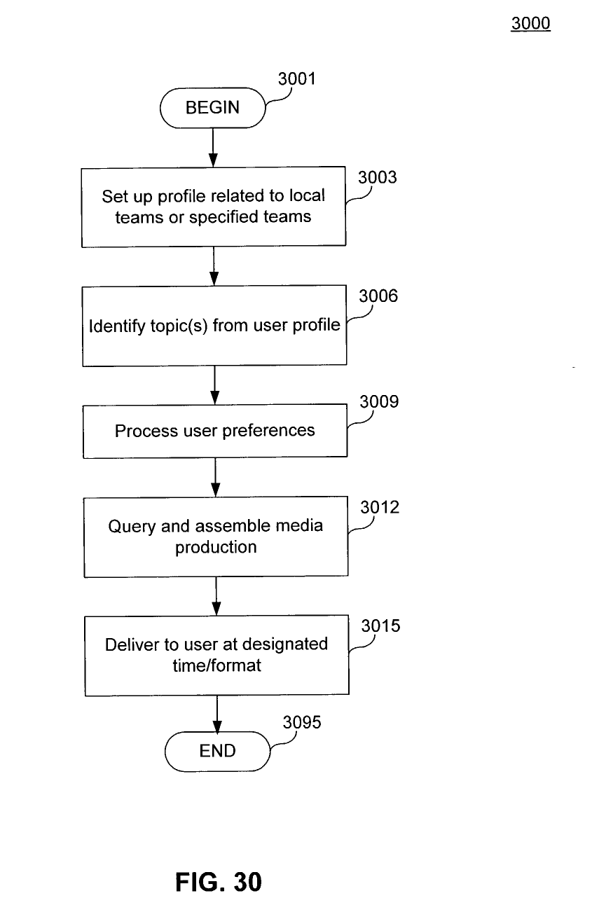

A sixth example of a control flow for customizing a production is shown in FIG. 30. Referring to FIG. 30, flowchart 3000 represents the general operational flow of another embodiment of the present invention. More specifically, flowchart 3000 shows an example of customizing a production based on the fifth topic shown in Table 1.

The control flow of flowchart 3000 begins at step 3001 and passes immediately to step 3003. At step 3003, a user profile is established to designate topics related to local teams, or a specified local or national team, such as the Florida State University Seminoles or the Washington Redskins. As described above, the user can specifically indicate an interest in this topic, or an inference engine or the like can consider the user's demographic, psychographic, or behavioral patterns to infer an interest in this topic.

At step 3006, the user's profile is collected and analyzed to identify or select the topic(s) of interest. In this case, the topic is local or specified teams, as specified in the user profile or determined by an inference engine. At step 3009, the user's other preferences are considered. Referring back to Table 1, in the fifth example, the user specifies a preferred time for receiving the media content as being one hour before every game. The user can enter the game schedule, or the present invention can obtain the schedule from a search engine or the like, such as a resource available through the Internet.

As discussed, the user may also indicate a preferred duration, file size, or other preferences. At step 3012, the user's profile is executed to select media matching the user's interests. As described herein, the media includes video, text articles, web sites, merchandising, audio feeds, etc. The selected media is assembled and compiled for transmission.

At step 3015, the media production is transmitted to the user's client as described above. The media production is transmitted at the designated time and format specified by the user. In the fifth example shown in Table 1, the production is delivered one hour before an upcoming game. After the customized media presentation has been transmitted, the control flow ends as indicated at step 3095.

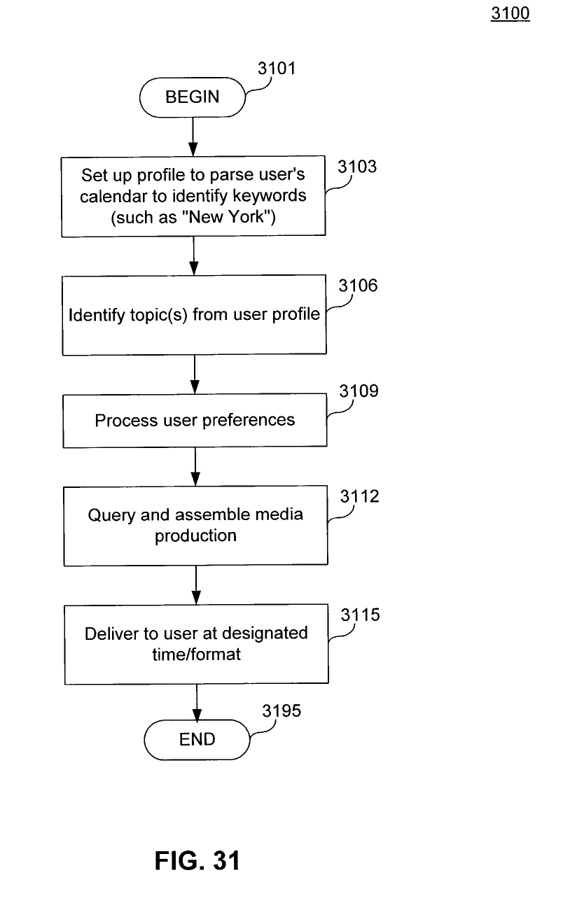

A seventh example of a control flow for customizing a production is shown in FIG. 31. Referring to FIG. 31, flowchart 3100 represents the general operational flow of another embodiment of the present invention. More specifically, flowchart 3100 shows an example of customizing a production based on the sixth topic shown in Table 1.

The control flow of flowchart 3100 begins at step 3101 and passes immediately to step 3103. At step 3103, a user profile is established to designate topics related the user's calendar. The user can expressly opt to have topics derived from the user's calendar. Alternatively, the present invention can automatically implement this embodiment. Accordingly, an inference engine or the like automatically parses the user's calendar to process information in the calendar events, appointments, tasks, etc. Keywords are selected from the parsed information, such as “New York.” Additionally, the user's demographic, psychographic, or behavioral patterns are analyzed from the calendar to infer an interest in one or more topic(s). For example, if the user has scheduled a significant quantity of lunch meetings, an interest in restaurants can be inferred. In another example, if the user receives a substantial quantity of email from educational institutions, an interest in education and training can be inferred.

At step 3106, the user's profile is collected and analyzed to identify or select the topic(s) of interest. In this case, the topic is “New York,” as inferred from parsing the calendar. At step 3109, the user's other preferences are considered, if designated. As discussed, such preferences include media type, format, duration, etc. The present invention may automatically execute this embodiment on a periodically scheduled basis, such as daily, weekly, or bi-monthly.

At step 3112, the user's profile is executed to select media matching the user's interests. As described herein, the media includes video, text articles, web sites, merchandising, audio feeds, etc. The selected media is assembled and compiled for transmission.

At step 3115, the media production is transmitted to the user's client as described above. The media production is transmitted at the designated time and format specified by the user, if specified. Otherwise, a default setting is implemented. After the customized media presentation has been transmitted, the control flow ends as indicated at step 3195.

V. System Overview of Enhanced Media Production and Distribution

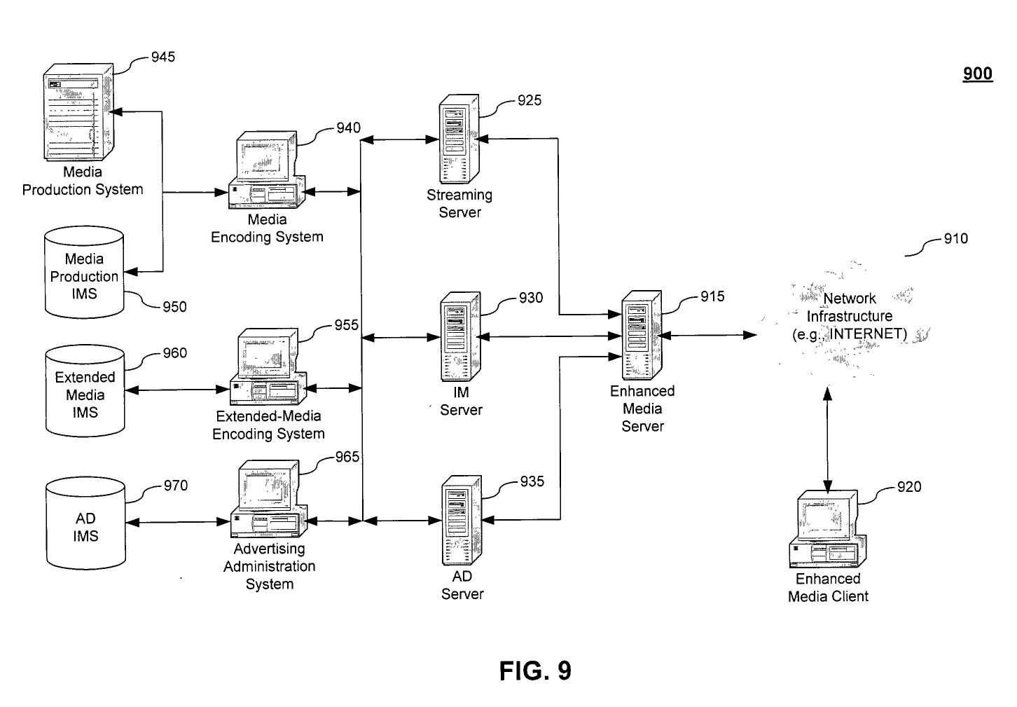

FIG. 9 illustrates a block diagram of an enhanced media production and distribution system 900 (herein referred to as “system 900”) useful for implementing an embodiment of the present invention. System 900 includes an enhanced media server 915 and one or more enhanced media clients 920. In an embodiment, enhanced media server 915 provides web pages for a hosting portal, homepage, or web site. The operator of the portal is a local television, radio station, newspaper, webcasting station, or other media “hosting” environment.

A network infrastructure 910 provides a medium for communication among enhanced media server 915 and enhanced media clients 920. Network infrastructure 910 includes wired and/or wireless local area networks (LAN) or wide area networks (WAN), such as an organization's intranet, a local internet, the global-based Internet (including the World Wide Web (WWW)), an extranet, a virtual private network, licensed wireless telecommunications spectrum for digital cell (including CDMA, TDMA, GSM, EDGE, GPRS, CDMA2000, WCDMA FDD and/or TDD or TD-SCDMA technologies), or the like. Network infrastructure 910 includes wired, wireless, or both transmission media, including satellite, terrestrial (e.g., fiber optic, copper, coaxial, hybrid fiber-coaxial (HFC), or the like), radio, microwave, and/or any other form or method of transmission.

Each enhanced media client 920 is a personal computer, personal digital assistant (PDA), telephone, television, MP3 player, or other device operable for wired or wireless exchanges over network infrastructure 910. Enhanced media clients 920 include a display having the ability to select one or more media segments. In an embodiment, enhanced media client 920 is located in an automobile, and can be a MP3 stereo or personal computer with a hard drive or flash data storage memory and capable of downloading music or music video files. Moreover, the user of an enhanced media client 920 includes human operators requesting a web page from enhanced media server 915 over the Internet, or another web site host, television or radio broadcaster, or the like.

Enhanced media server 915 is connected to a streaming server 925, information management (IM) server 930, and advertisement server 935. Streaming server 925 supports live and on-demand streaming functionality of system 900. Streaming server 925 transmits media streams by interacting with media encoding system 940, media production system 945, media production information management system (IMS) 950, extended-media encoding system 955, and extended-media IMS 960. Streaming server 925 and enhanced media server 915 are configurable to provide continuous, seamless streams for real-time or near-term presentations, as well as download data files to enhanced media client 920 for delayed playback. The media streams can either be continuous as represented by a complete show broadcast over traditional mediums, or modified according to the interests of the user of enhanced media client 920, reassembled and streamed in the new configuration. In either case, the streaming process only requires a single download, buffering and playout process. In another embodiment, it is contemplated that for on-demand requests, that a user (client) can schedule the request in advance, have the media files transferred or expedited (FTP or some other file transfer technology) for local storage on the client ready for playout upon user access and/or request.

IM server 930 is an indexing system that enables the other system components to query system 900 for data and metadata. For example, enhanced media server 915 is operable to query IM server 930 for the location or filename of a specific video segment. The query results from IM server 930 are communicated to streaming server 925 which, in turn, locates the requested video segment for transmission to the requesting enhanced media client 920.

Finally, advertisement server 935 is connected to an advertising administration system 965 and an advertisement (AD) IMS 970. Advertisement server 935 provides advertisements (such as, commercials in audio or video format, banners, active media, or the like) that are integrated into a media stream (e.g., video segment) requested by an online user. As described in detail below, advertisements can be requested by any of the other system components and integrated into a media stream at any point in the media production process.

Enhanced media server 915 commands and controls the operational capabilities of system 900. As a result, enhanced media server 915 functions as a portal to process or service requests for media produced or archived within system 900. Enhanced media server 915 also implements policies and rules to enforce security protocols to protect system and data integrity, including user authentication, user roles, or the like.

In an embodiment, enhanced media server 915 or at least one of its supporting system components (i.e., streaming server 925, IM server 930, advertisement server 935, media encoding system 940, media production system 945, etc.) is located at the facilities of a local television, radio station, newspaper, webcasting station, or other media hosting environment. However, enhanced media server 915 or at least one of its supporting system components can also be remotely located and configured to communicate with a television or radio station functioning as a content source. In other embodiments, enhanced media server 915 or at least one of its supporting system components are locally or remotely positioned at a private residence, place of business, educational institution, government agency, or the like, and utilized for media production and network distribution.

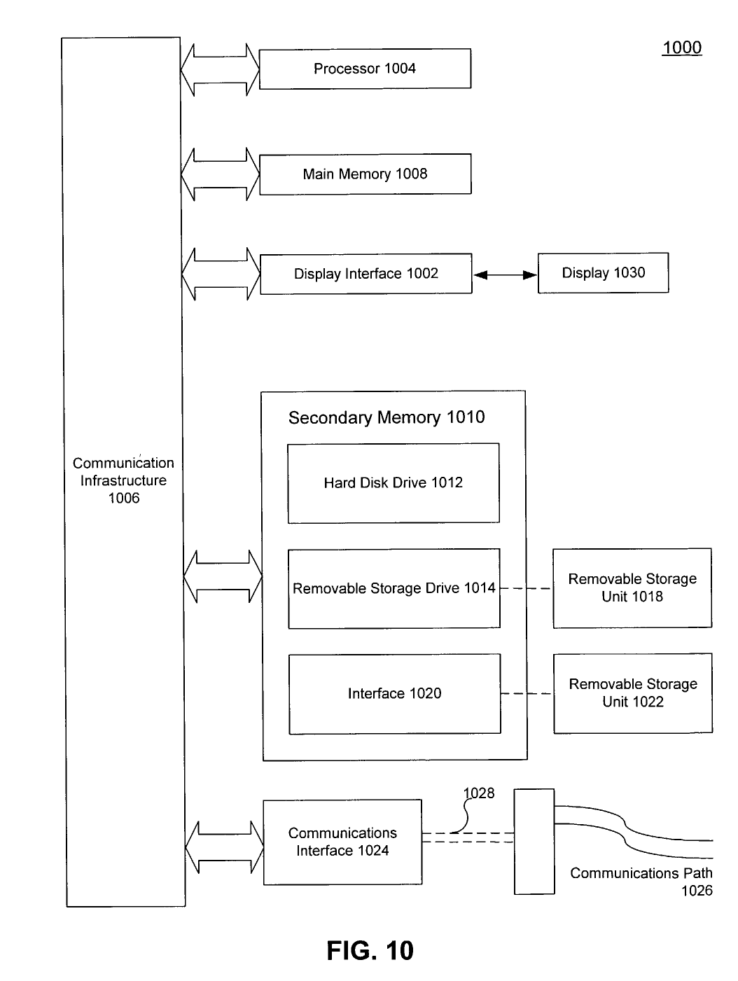

The system components are operable to query and write to various archival and retrieval systems, such as media production IMS 950, extended-media IMS 960, and advertisement IMS 970. In an embodiment, a media production is stored in an archival and retrieval system after the content is created or retrieved, and labeled (if not properly marked with a content production code, URL, or the like). The archival and retrieval system can include a secondary memory (such as, secondary memory 1010 described with reference to FIG. 10 below). To support larger volumes of content, one or more integrated databases or a data warehouse system is used to store the content to support the respective server as described herein. In an embodiment, the archival and retrieval system includes a relational or object oriented (OO)/component based database management system (not shown), or the like, that controls the storing, retrieving and updating of data and metadata in the database records. The database management system also controls data integration, enforces integrity rules and constraints (including data integrity and referential integrity), and enforces security constraints.

The archival and retrieval system is a scalable system that stores data on multiple disk arrays. Data warehousing can be implemented with the SQL Server 2000 application available from Microsoft Corporation, the Oracle 9i™ database available from Oracle Corporation (Redwood City, Calif.), or the like. The archival and retrieval system supports Open DataBase Connectivity (ODBC) or Java DataBase Connectivity (JDBC) protocols.

The archival and retrieval system can be centrally located or a widely distributed system. In an embodiment, one or more components of the archival and retrieval system are located at the same facilities of the querying system. In another embodiment, one or more components of the archival and retrieval system are located at the facilities of the originator of the content. Accordingly, the querying system component (e.g., media production system 945) requests the content (e.g., video of a news story) by a content production code, URL, or the like. In another embodiment, one or more components of the archival and retrieval system is located or managed by a third party. Therefore, the content originator would send or license the content to the third party, and the querying system component (e.g., media production system 945) would request the content by using the content production code, URL, or the like.

FIG. 9 represents a conceptual illustration of system 900 to allow a structural explanation of the present invention. That is, one or more of the blocks can be performed by the same piece of hardware or module of software. It should also be understood that embodiments of the present invention can be implemented in hardware, software, firmware, or a combination thereof. In such an embodiment, the various components and steps would be implemented in hardware, firmware, and/or software to perform the functions of the present invention.

In an embodiment, each server within system 900 represents one or more computers providing various shared resources with each other and to the other network computers. In another embodiment, a single computer functions as all servers in system 900, and provides various shared resources to the other network computers (e.g., enhanced media client 920). In another embodiment, only server 915 is a single computer providing shared resources. As apparent to one skilled in the relevant art(s), other system components of system 900 can be combined or separated, and are considered to be within the scope of the present invention.

The shared resources include files for programs, web pages, databases and libraries; output devices, such as, printers, plotters, display monitors and facsimile machines; and communications devices, such as modems and Internet access facilities. The communications devices can support wired or wireless communications, including satellite, terrestrial (fiber optic, copper, coaxial, and the like), radio, microwave and any other form or method of transmission.

In an embodiment, each server is configured to support the standard Internet Protocol (IP) developed to govern communications over public and private Internet backbones. The protocol is defined in Internet Standard (STD) 5, Request for Comments (RFC) 791 (Internet Architecture Board). The servers also support transport protocols, such as, Transmission Control Protocol (TCP), User Datagram Protocol (UDP), Real Time Transport Protocol (RTP), or Resource Reservation Protocol (RSVP). The transport protocols support various types of data transmission standards, such as File Transfer Protocol (FTP), Hypertext Transfer Protocol (HTTP), Simple Network Management Protocol (SNMP), Network Time Protocol (NTP), or the like.

In an embodiment, each server is configured to support various operating systems, such as, the Netware™ operating system available from Novell, Inc. (Provo, Utah); the MS-DOS®, Windows NT® and Windows® 3.xx/95/98/2000 operating systems available from Microsoft Corporation; the Linux® operating system available from Linux Online Inc. (Laurel, Md.); the Solaris™ operating system available from Sun Microsystems, Inc. (Palo Alto, Calif.); or the like as would be apparent to one skilled in the relevant art(s).

Additionally, the present invention (e.g., system 900 or any part thereof) can be implemented in one or more computer systems or other processing systems. In fact, in an embodiment, the invention is directed toward one or more computer systems capable of carrying out the functionality described herein.

Referring to FIG. 10, an example computer system 1000 useful in implementing the present invention is shown. The computer system 1000 includes one or more processors, such as processor 1004. The processor 1004 is connected to a communication infrastructure 1006 (e.g., a communications bus, crossover bar, or network). Various software embodiments are described in terms of this exemplary computer system. After reading this description, it will become apparent to one skilled in the relevant art(s) how to implement the invention using other computer systems and/or computer architectures.

Computer system 1000 can include a display interface 1002 that forwards graphics, text, and other data from the communication infrastructure 1006 (or from a frame buffer not shown) for display on the display unit 1030.

Computer system 1000 also includes a main memory 1008, preferably random access memory (RAM), and can also include a secondary memory 1010. The secondary memory 1010 can include, for example, a hard disk drive 1012 and/or a removable storage drive 1014, representing a floppy disk drive, a magnetic tape drive, an optical disk drive, etc. The removable storage drive 1014 reads from and/or writes to a removable storage unit 1018 in a well-known manner. Removable storage unit 1018, represents a floppy disk, magnetic tape, optical disk, etc. which is read by and written to removable storage drive 1014. As will be appreciated, the removable storage unit 1018 includes a computer usable storage medium having stored therein computer software and/or data.

In alternative embodiments, secondary memory 1010 can include other similar means for allowing computer programs or other instructions to be loaded into computer system 1000. Such means can include, for example, a removable storage unit 1022 and an interface 1020. Examples of such can include a program cartridge and cartridge interface (such as that found in video game devices), a removable memory chip (such as an EPROM, or PROM) and associated socket, and other removable storage units 1022 and interfaces 1020 which allow software and data to be transferred from the removable storage unit 1022 to computer system 1000.

Computer system 1000 can also include a communications interface 1024. Communications interface 1024 allows software and data to be transferred between computer system 1000 and external devices. Examples of communications interface 1024 can include a modem, a network interface (such as an Ethernet card), a communications port, a PCMCIA slot and card, etc. Software and data transferred via communications interface 1024 are in the form of signals 1028 which can be electronic, electromagnetic, optical, or other signals capable of being received by communications interface 1024. These signals 1028 are provided to communications interface 1024 via a communications path (i.e., channel) 1026. This channel 1026 carries signals 1028 and can be implemented using wire or cable, fiber optics, a phone line, a cellular phone link, an RF link, and other communications channels.

In this document, the terms “computer program medium” and “computer usable medium” are used to generally refer to media such as removable storage drive 1014, a hard disk installed in hard disk drive 1012, and signals 1028. These computer program products are means for providing software to computer system 1000. The invention is directed to such computer program products.

Computer programs (also called computer control logic) are stored in main memory 1008 and/or secondary memory 1010. Computer programs can also be received via communications interface 1024. Such computer programs, when executed, enable the computer system 1000 to perform the features of the present invention as discussed herein. In particular, the computer programs, when executed, enable the processor 1004 to perform the features of the present invention. Accordingly, such computer programs represent controllers of the computer system 1000.

In an embodiment where the invention is implemented using software, the software can be stored in a computer program product and loaded into computer system 1000 using removable storage drive 1014, hard drive 1012 or communications interface 1024. The control logic (software), when executed by the processor 1004, causes the processor 1004 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to one skilled in the relevant art(s).

In yet another embodiment, the invention is implemented using a combination of both hardware and software.

VI. Enhanced Media Production and Storage

As discussed, the present invention supports live and on-demand distribution of media productions over a widely distributed computer network. In an embodiment, present invention is configurable to receive, generate, or transmit media productions from a variety of sources. Referring back to FIG. 9, media production system 945 is one media source for system 900. Media production system 945 is representative of a manual multimedia production environment, or an automated multimedia production system, as discussed above with reference to FIGS. 1-5. The application entitled “Method, System and Computer Program Product for Producing and Distributing Enhanced Media Downstreams” (U.S. patent application Ser. No. 09/836,239) describes representative embodiments of manual and automated multimedia production systems that are implementable with the present invention, and are incorporated herein.

In an automated multimedia production environment, a media production processing device, such as media production system 945, automatically or semi-automatically commands and controls the operation of a variety of media production devices in analog and/or digital video environments. The term “media production device” includes video switcher, digital video effects device (DVE), audio mixer, teleprompting system, video cameras and robotics (for pan, tilt, zoom, focus, and iris control), record/playback device (RPD), character generator, still store, studio lighting devices, news automation devices, master control/media management automation systems, commercial insertion devices, compression/decompression devices (codec), virtual sets, or the like. The term “RPD” includes VTRs, video recorders/servers (e.g., media production IMS 950), virtual recorder (VR), digital audio tape (DAT) recorder, or any mechanism that stores, records, generates or plays back via magnetic, optical, electronic, or any other storage media. In an embodiment, the media production processing device receives and routes live feeds (such as, field news reports, news services, sporting events, or the like) from any type of communications source, including satellite, terrestrial (e.g., fiber optic, copper, coaxial, HFC, or the like), radio, microwave, or any other form or method of video transmission, in lieu of, or in addition to, producing a live show within a studio.

In addition to controlling media production devices, an automated media production processing device is configurable to convert an electronic show rundown (e.g., show rundown 2402) into computer readable broadcast instructions to automate the execution of a show without the need of an expensive production crew to control the media production devices. As previously discussed, in an embodiment, the broadcast instructions are created from the Transition Macro™ multimedia production control program developed by ParkerVision, Inc.

FIG. 11 illustrates an embodiment of an object-oriented, electronic show rundown (e.g., show rundown 2402) created by an event-driven application on a graphical user interface (GUI) 1100. The electronic rundown includes a horizontal timeline 1102 and one or more horizontal control lines 1104a-1104p. Automation control icons 1106a-1106t are positioned onto control lines 1104a-1104p at various locations relative to timeline 1102, and configured to be associated with one or more media production commands and at least one media production device.

A timer (not shown) is integrated into timeline 1102, and operable to activate a specific automation control icon 1106a-1106t as a timer indicator 1108 travels across timeline 1102 to reach a location linked to the specific automation control icon 1106. As a result, media production processing device would execute the media production commands to operate the associated media production device.

In regards to automation control icons 1106a-1106t, label icon 1106a permits a director to name one or more elements, segments, or portions of the electronic rundown. In embodiment, the director would drag and drop a label icon 1106a onto control line 1104a, and double click on the positioned label icon 1106a to open up a dialogue box to enter a text description. The text would be displayed on the positioned label icon 1106a. Referring to FIG. 11, exemplary label icons 1106a have been generated to designate “A01,” “CUE,” “OPEN,” “A02,” etc.

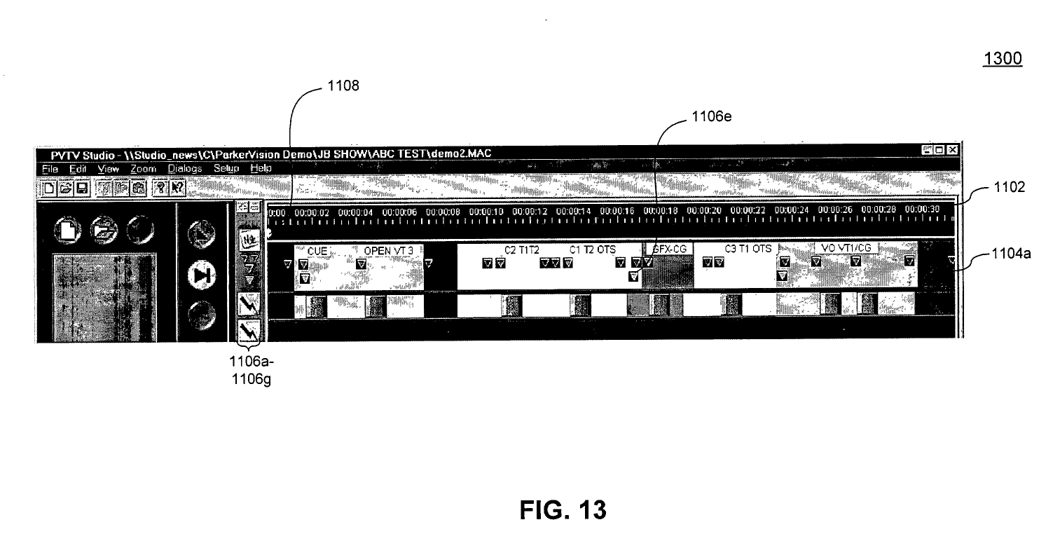

Control line 1104a is also operable to receive a step mark icon 1106b, a general purpose input/output (GPI/O) mark icon 1106c, a user mark icon 1106d, and an encode mark 1106e. Encode mark 1106e is described in detail below with reference to FIG. 13. Step mark icon 1106b and GPI/O mark icon 1106c are associated with rundown step commands. The rundown step commands instruct timer indicator 1108 to start or stop running until deactivated or reactivated by the director or another media production device. For example, step mark icon 1106b and GPI/O mark icon 1106c can be placed onto control line 1104a to specify a time when timer indicator 1108 would automatically stop running. In other words, timer indicator 1108 would stop moving across timeline 1102 without the director having to manually stop the process, or without another device (e.g., a teleprompting system (not shown)) having to transmit a timer stop command. If a step mark icon 1106b is activated to stop timer indicator 1108, timer indicator 1108 can be restarted either manually by the director or automatically by another external device transmitting a step command. If a GPI/O mark icon 1106c is used to stop timer indicator 1108, timer indicator 1108 can be restarted by a GPI or GPO device transmitting a GPI/O signal.

In an embodiment, step mark icon 1106b and GPI/O mark icon 1106c are used to place a logically break between two elements on the electronic rundown. In other words, step mark icon 1106b and GPI/O mark icon 1106c are placed onto control line 1140a to designate segments within a media production. One or more configuration files can also be associated with a step mark icon 1106b and GPI/O mark icon 1106c to link metadata with the designated segment.

Transition icons 1106f-1106g are associated with automation control commands for controlling video switching equipment. Thus, transition icons 1106f-1106g can be positioned onto control lines 1104b-1104c to control one or more devices to implement a variety of transition effects or special effects into a media production. Such transition effects include, but are not limited to, fades, wipes, DVE, downstream keyer (DSK) effects, and the like. DVE includes, but is not limited to, warps, dual-box effects, page turns, slab effects, and sequences. DSK effects include DVE and DSK linear, chroma and luma keyers.

Keyer control icon 1106h is positioned on control line 1104d, and used to prepare and execute keyer layers either in linear, luma, chroma or a mix thereof for preview or program output. The keyers can be upstream or downstream of the DVE.

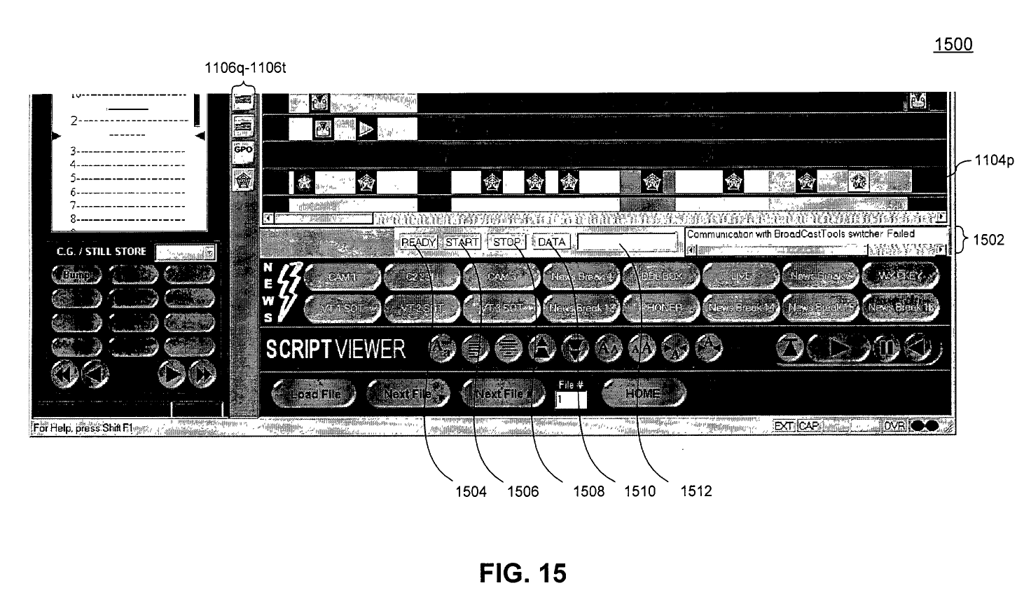

Audio icon 1106i can be positioned onto control line 1104e and is associated with commands for controlling audio equipment, such as audio mixers, digital audio tape (DAT), cassette equipment, other audio sources (e.g., CDs and DATs), and the like. Teleprompter icon 1106j can be positioned onto control line 1104f and is associated with commands for controlling a teleprompting system to integrate a script into the timeline. Character generator (CG) icon 1106k can be positioned onto control line 1104g and is associated with commands for controlling a CG or still store to integrate a CG page into the timeline. Camera icons 1106l-1106n can be positioned onto control lines 1104h-1104j and are associated with commands for controlling the movement and settings of one or more cameras. VTR icons 1106p-1106r can be positioned onto control lines 1104k-1104m and are associated with commands for controlling VTR settings and movement. GPO icon 1106s can be positioned onto control line 1104n and is associated with commands for controlling GPI or GPO devices. Encode object icon 1106t can be positioned onto control line 1104p and is associated with encoding commands which are described in detail below with respect to FIG. 15.

User mark icon 1106d is provided to precisely associate or align one or more automation control icons 1106a-1106c and 1104e-1104t with a particular time value. For example, if a director desires to place teleprompter icon 1106j onto control line 1104f such that the timer value associated with teleprompter icon 1106j is exactly 10 seconds, the director would first drag and drop user mark icon 1106d onto control line 1104a at the ten second mark. The director would then drag and drop teleprompter icon 1106j onto the positioned user mark icon 1106d. Teleprompter icon 1106j is then automatically placed on control line 1104f such that the timer value associated with teleprompter icon 1106j is ten seconds. In short, any icon that is drag and dropped onto the user mark 1106d is automatically placed on the appropriate control line and has a timer value of ten seconds. This feature helps to provide multiple icons with the exact same timer value.

After the appropriate automation control icons 1106 have been properly position onto the electronic rundown, the electronic rundown can be stored in a file for later retrieval and modification. Accordingly, a show template or generic electronic rundown can be re-used to produce a variety of different shows. A director could recall the show template by filename, make any required modifications (according to a new electronic rundown), and save the electronic rundown with a new filename.

As described above, one media production device is a teleprompting system (not shown) that includes a processing unit and one or more displays for presenting a teleprompting script (herein referred to as “script”) to the talent. In an embodiment, the teleprompting system is the SCRIPT Viewer™, available from ParkerVision, Inc. As described in the application entitled “Method, System and Computer Program Product for Producing and Distributing Enhanced Media Downstreams” (U.S. patent application Ser. No. 09/836,239), a teleprompting system can be used to create, edit, and run scripts of any length, at multiple speeds, in a variety of colors and fonts. In an embodiment of the present invention, the teleprompting system is operable to permit a director to use a text editor to insert media production commands into a script (herein referred to as “script commands”). The text editor can be a personal computer or like workstation, or the text editor can be an integrated component of electronic rundown GUI 1100. Referring to FIG. 11, text window 1110 permits a script to be viewed, including script commands. Script controls 1112 are a set of graphical controls that enable a director to operate the teleprompting system and view changes in speed, font size, script direction and other parameters of the script in text window 1110.

The script commands that can be inserted by the teleprompting system include a cue command, a delay command, a pause command, a rundown step command, and an enhanced media command. As discussed below, enhanced media commands permit the synchronization of auxiliary information to be linked for display or referenced with a script and video. This allows the display device to display streaming video, HTML or other format graphics, or related topic or extended-play URLs and data. The present invention is not limited to the aforementioned script commands. As would be apparent to one skilled in the relevant art(s), commands other than those just listed can be inserted into a script.

VII. Web Cast Production

As discussed, embodiments of the present invention are operable to receive, generate, or transmit media productions from a variety of sources over a widely diverse computer network. Referring back to FIG. 9, in an embodiment, enhanced media server 915 supports client requests for on-demand and customizable broadcasts of a show or selected segments from a show. To enable this functionality, encoded metadata that is descriptive of the segments is created during a media production and saved in an archival and retrieval system (e.g., media production IMS 950, extended-media IMS 960, etc.) in real time. Subsequently, the video frames from a show can be retrieved by the associated metadata, such as the content production code (e.g., time code, frame code, or the like).

Referring back to FIG. 9, an encoding process is implemented by media encoding system 940 or extended-media encoding system 955. Irrespective of whether the content is prepared by manual or automated production techniques, media production system 945 or media production IMS 950 transmits the content to media encoding system 940 to be prepared for transmissions over network infrastructure 910. Similarly, extended-media encoding system 955 operates to prepare extended-media content from extended-media IMS 960 for online transmissions. In an embodiment, media encoding system 940 and extended-media encoding system 955 use a serial digital interface (SDI) to receive the content. However, the present invention can also be implemented with composite, Y/C, RGB or component analog video or any other parallel interfacing.

In an embodiment, media encoding system 940 and extended-media encoding system 955 (collectively referred to as “encoding system”) multiplexes media content (e.g., video segment) and metadata into a single media stream. The extended-media encoding system 955 also provides a secondary encoder to enter additional source video and/or ad video or any other source that requires encoding while the media encoding system 940 is in operation. In an embodiment, the encoding system converts uncompressed video or audio data to compressed digital streams or files. The encoding system is configurable to compress video files (e.g., avi format), audio clips (e.g., wav format), and still images (e.g., bmp or jpg formats) into an MPEG format or the like. The encoding system is also configurable to re-encode an existing MPEG file, or the like, to modulate the file parameters (e.g., bit rate, video dimensions, frame rates, sampling rates, and the like). Finally, the encoding system can be configured to index or catalog the encoded media streams, or segments of the encoded media streams. Indexing or cataloging reduces the encoding processing time and memory requirements for future transmissions of the same streams.

As described above, the encoding system of the present invention is operable with both an automated and manually-operated configuration of media production system 945. With both content sources, the encoding system formats the media content with timeline-based techniques or methodologies.

Referring back to FIG. 11, GUI 1100 illustrates an embodiment of an electronic rundown (e.g., rundown 2404) that can be used to encode a media production from an automated environment. As discussed above, control lines 1104a-1104n contain automation control icons 1106a-1106s that are operable to automatically control media production devices and produce a video show. However, control lines 1104a and 1104p are used to enter encode mark 1106e and encode object icon 1106t, respectively, that are associated with encoding commands. As timer indicator 1108 moves across timeline 1102, the associated encode mark 1106e and encode object icon 1106t send commands to the encoding system to format the media streams.

In an embodiment, a director can enter encode mark 1106e and encode object icon 1106t onto control lines 1104a and 1104p, respectively, when the director uses media production system 1145 to place the other automation control icons 1106a-1106d and 1106f-1106s that are associated with other media production commands onto control lines 1104a-1104n. In another embodiment, a director can enter encode mark 1106e and encode object icon 1106t after the media production has been completed and approved. In this embodiment, the director could use either media production system 1145 or media encoding system 1140 to enter encode mark 1106e and encode object icon 1106t.

Thus, the presence of encode mark 1106e and/or encode object 1106t transforms GUI 1100 into an encoder rundown (e.g., show rundown 2402 or shadow rundown 2404). Referring back to FIG. 1, show rundown 2402 includes instructions (e.g., encode mark 1106e and/or encode object 1106t) for formatting a media steam for transmission (e.g., electronic show 2408) over a computer network. In this embodiment, show rundown 2402 functions as an encoder rundown. Likewise, referring back to FIGS. 3-5, shadow rundown 2404 includes instructions (e.g., encode mark 1106e and/or encode object 1106t) for formatting a media steam for transmission (e.g., electronic show 2408) over a computer network. As such, shadow rundown 2404 also functions as an encoder rundown.

In an embodiment where encode mark 1106e and/or encode object 1106t are not present, GUI 1100 is only an electronic rundown (e.g., show rundown 2402) for automated media production. Referring back to FIGS. 3-5, show rundown 2402 does not include instructions (e.g., encode mark 1106e and/or encode object 1106t) for formatting a media stream for transmission (e.g., electronic show 2408) over a computer network. Show rundown 2402, in these embodiments, only provide media production commands for producing traditional show 2406.

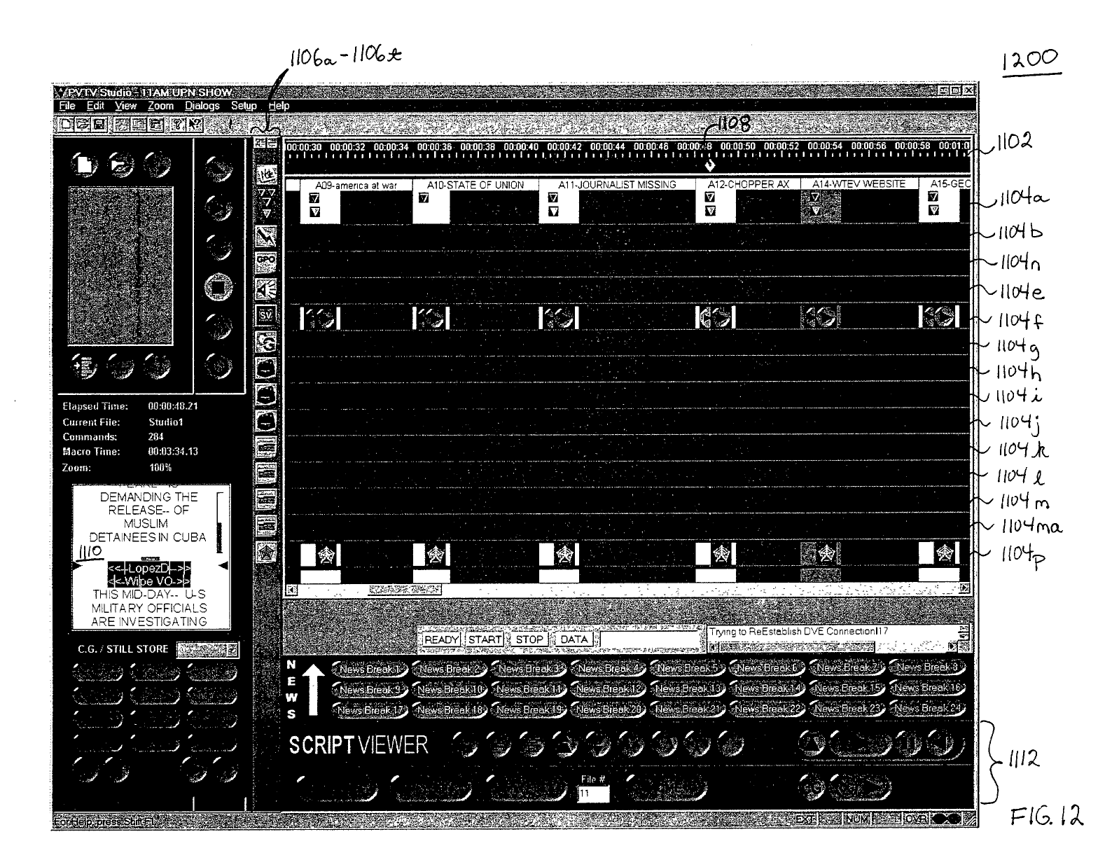

Referring to FIG. 12, GUI 1200 illustrates another embodiment of an encoder rundown (e.g., shadow rundown 2404) used to encode a media production from an automated environment. Control lines 1104a-1104n are enabled to receive automation control icons 1106a-1106s that are operable to automatically control media production devices and produce a video show. However, in embodiment, the encoder rundown (e.g., shadow rundown 2404) is only used to encode the media production, and, therefore, most of control lines 1104a-1104n are inoperable. Nonetheless, control lines 1104a-1104n allows a web director to integrate and/or control auxiliary information associated with a media production. As shown, teleprompter icon 1106j can be positioned onto control line 1104f and enables a script to be linked to the media production to support captioning or like features.

Control lines 1104a and 1104p are available to receive encode mark 1106e and encode object icon 1106t, respectively, that are associated with encoding commands. As described, each activated encode mark 1106e and encode object icon 1106t send commands to the encoding system to format the media streams.

FIG. 13 illustrates the top region of GUI 1100 or GUI 1200 (shown as GUI 1300) to provide a view of control line 1104a. Control line 1104a is used to enter icons 1106a-1106d that are associated with step commands and icon alignment commands, as discussed above. Another automation control icon that can be placed on control line 1104a is encode mark 1106e. In an embodiment, encode mark 1106e operates like a Web Mark™ developed by ParkerVision, Inc. During the encoding process, encode mark 1106e identifies a distinct segment within a media production. As timer indicator 1108 advances beyond encode mark 1106e, the encoding system is instructed to index the beginning of a new segment. In an embodiment, as the encoding process is executed, media encoding system 940 automatically clips the media production into separate files based on the placement of encode mark 1106e. This facilitates the indexing, cataloging and future recall of segments identified by the encode mark 1106e.

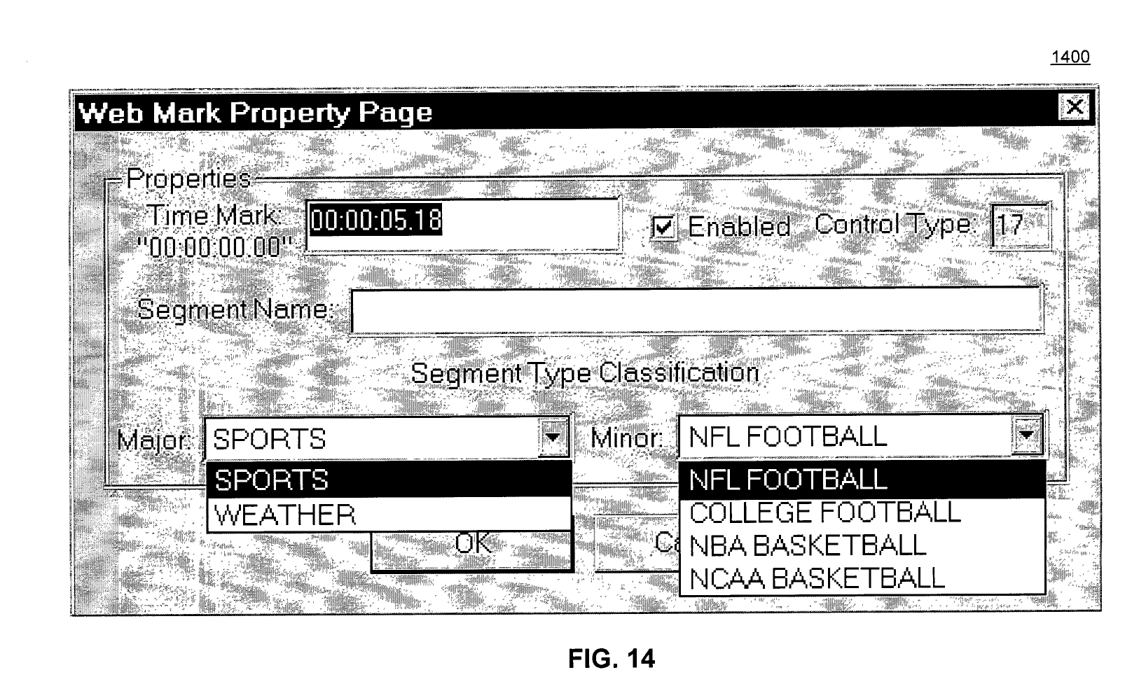

In an embodiment, the properties of each encode mark 1106e are established by activating encode mark 1106e to open a configuration GUI. FIG. 14 illustrates an embodiment of an encode mark configuration GUI 1400. GUI 1400 can be used to set the time for initiating the encoding commands associated with encode mark 1106e. The time can be manually entered or is automatically entered at the time of placing encode mark 1106e on control line 1104a. GUI 1400 also permits an operator to designate a name for the segment, and specify the segment type classification. Segment type classification includes a major and minor classification. For example, a major classification or topic can be sports, weather, headline news, traffic, health watch, elections, and the like. Exemplary minor classifications or category can be local sports, college basketball, NFL football, high school baseball, local weather, national weather, local politics, local community issues, local crime, editorials, national news, and the like. Classifications can expand beyond two levels to an unlimited number of levels for additional granularity and resolution for segment type identification and advertisement targeting. In short, the properties associated with each encode mark 1106e provide a set of metadata that can linked to a specific segment. These properties can be subsequently searched to identify or retrieve the segment from an archive.

FIG. 15 illustrates the bottom region of GUI 1100 or GUI 1200 (shown as GUI 1500) to provide a view of control line 1104p. Control line 1104p is used to enter icons automation control icon 1106t that is associated with encoded transmission commands. The encoded transmission commands instructs the encoding system to start or stop the encoding process until deactivated or reactivated by an operator or another media production device.

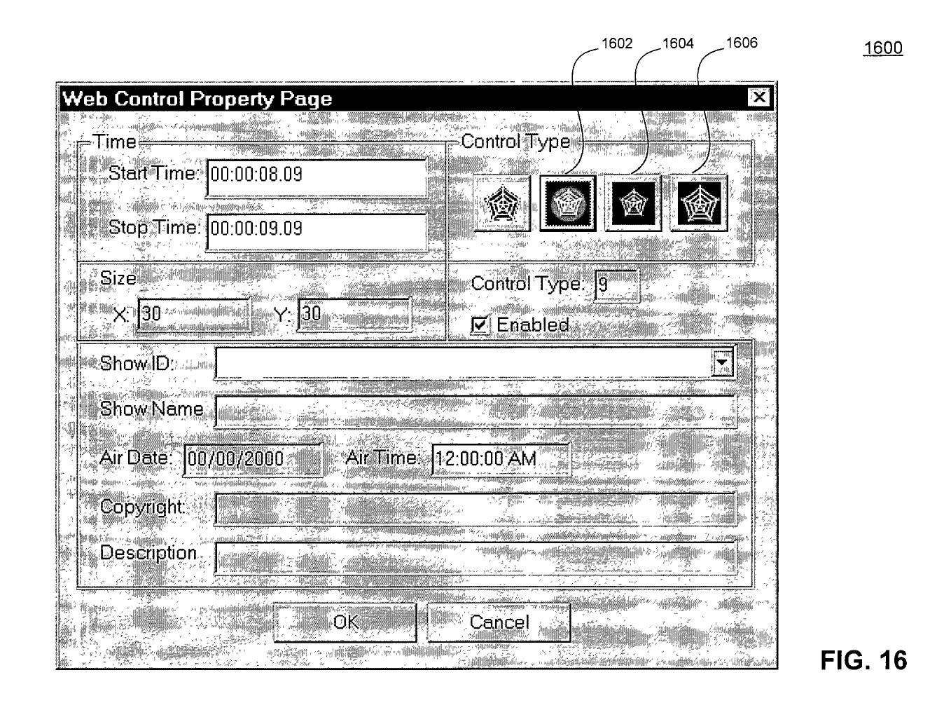

Encode object icons 1106t are placed on control line 1104p to produce encode objects. In an embodiment, encode object icon 1106t operates like Web Objects™ developed by from ParkerVision, Inc. FIG. 16 illustrates an embodiment of a configuration GUI 1600 that can be used to set the searchable properties of each encode object icon 1106t. In this embodiment, start stream object 1602, data object 1604 and stream stop object 1606 are three types of encode object icons 1106t that can be used. Start stream object 1602 initializes the encoding system and starts the encoding process. In comparison with encode mark 1106e, start stream object 1602 instructs the encoding system to start the encoding process to identify a distinct show, whereas encode mark 1106e instructs the encoding system to designate a portion of the media stream as a distinct segment. The metadata contained in start stream object 1602 is used to provide a catalog of available shows, and the metadata in encode mark 1106e is used to provide a catalog of available show segments.

Data object 1604 is used to identify auxiliary information to be displayed with the media stream. As described in detail below, auxiliary information includes graphics or text in a HTML page and is referenced in GUI 1600 by its URL address.

Stream stop object 1606 is used to stop the encoding process and designate the end of a distinct show. Once timer indicator 1108 passes the stream stop object 1606, the encoding system would start the post-production processes, such as, including indexing segments, cataloging segments, pacing script, and the like.

The encoding start and stop times can be manually entered into GUI 1600 or automatically updated upon placement of start stream object 1602, data object 1604 or stop stream object 1606 onto control line 1104p. GUI 1600 also permits one to designate a show identifier, show name or description for the production. Other properties include the scheduled or projected air date and air time for the production. A copyright field is provided to specify any restrictions placed on the use or re-use of a specific show or show segment. For example, a broadcasting studio may not have a license to transmit a specific content on the Internet, but may have permission to provide the content over a private network or the airwaves, or vice versa. The content can be restricted for educational uses, single broadcast, transmissions to designated clients, or the like. In an embodiment, the appropriate component of system 900 (e.g., enhanced media server 915, streaming server 925, IM server 930, etc.) verifies the copyright field prior to streaming the content to an enhanced media client 920.

Referring back to FIG. 11 and FIG. 15, as timer indicator 1108 moves or passes over each encode object icon 1106t (i.e., start stream object 1602, data object 1604, or stop stream object 1606), the associated encoding commands are automatically processed. However, the present invention enables an operator to manually alter the encoding process during execution. In particular, encoding control region 1502 provides a set of graphical controls that enable an operator to modify the encoding process. The encoding graphical controls include a ready control 1504, start control 1506, stop control 1508, and data control 1510.

Ready control 1504 has an “activate” state and “de-activate” state. As such, ready control 1504 is operable to send “read” or “not read” commands to timer indicator 1108 depending on whether ready control 1504 is operating in an activate or de-activate state, respectively. In an embodiment, when ready control 1504 is operating in an activate state, timer indicator 1108 signals the encoding system to read and process the associated encoding commands as timer indicator 1108 passes each encode object icon 1106t and encode mark 1106e. Similarly, when deactivated, ready control 1504 instructs timer indicator 1108 to signal the encoding system to not read the encoding commands associated with each encode object icon 1106t and encode mark 1106e. Therefore, when ready control 1504 is de-activated, ready control 1504 allows directors to perform test runs to preview a show prior to the broadcast. A preview mode is desirable to allow directors to check the show to make sure that the correct sources and transitions are selected.

Start control 1506 is used to initiate the encoding system manually. In an embodiment, start control 1506 is operable to manually override a deactivate state established by ready control 1504 or stop control 1508 (discussed below). Start control 1506 can be used to manually activate the encoding process to send media streams to streaming server 925 that contain time-sensitive production elements, such as a breaking news element, or other manually prepared media productions.

Stop control 1508 is operable to deactivate the encoding process and stop transmissions to streaming server 925. Stop control 1508 would deactivate an encoding process initiated by either ready control 1504 or start control 1506. Stop control 1508 provides directors with the ability to stop the encoding system manually to avoid airing any unauthorized content as an example.

Data control 1510 is used to enter auxiliary information and link the information to a specific segment or an entire show. The auxiliary information is entered by typing the URL reference in reference window 1512 and activating data control 1510. Accordingly, auxiliary information can be entered via the configuration GUI 1600 for data object 1604 or reference window 1512. Data control 710 enables directors to enter URLs at any time during manual operations.

FIG. 17 illustrates another embodiment of an interactive electronic rundown GUI 1700 for encoding a media production. GUI 1700 is primarily configured to support a stand-alone embodiment for processing media produced from manual or conventional media production methodologies or techniques, but is also used in automated environments as an approval process to fine tune the beginning and end of segments. Additionally in an automated environment, GUI 1700 can be configured to add, delete or modify segments and links before preparing them for on-demand access. In either case, the media content does not need to be produced in an automated production environment. Even if the media is produced in an automated production environment, the encoding system can be implemented without the media production commands provided from control lines 1104a-1104n shown in FIG. 11.

Referring back to FIG. 17, GUI 1700 includes a descriptive bar 1702, horizontal timeline 1102, timer indicator 1108, and control lines 1704a-1704b. Descriptive bar 1702 identifies specific segments of a media production. For example, if the media production is a newscast, each region within descriptive bar 1702 can be used to label each story or feature of the broadcast, such as finance, weather, sports, health watch, commercial advertisement, story 1, story 2, or the like.

An editor or director uses control line 1704a to place a segment mark icon 1706 (shown as 1706a and 1706b). Segment mark icon 1706 identifies the start of an element, segment, or show. By default, segment mark icon 1706 also identifies a stopping point for a respective element. Since these icons identify each element individually, they allow the editor or director to edit out any particular story, commercial, or the like. Segment mark icon 1706 is similar to encode mark 1106e by being configurable to initiate encoding commands to designate a segment name, and specify a segment type classification.

Segment mark icon 1706 can also be used to cut, edit, or fragment a media production. When activated, segment mark icon 1706 instructs the encoding system to label and catalog the designated region of the media stream, so that a specific segment can be retrieved for future productions. Segment mark icon 1706 is also used to cut a segment prior to its actual completion. This can be used to remove unwanted portions of a segment. It can also be used to remove a segment portion to insert another video segment or commercial.

For example, descriptive bar 1702 show twelve news story elements (i.e., Story 1, Story 2, etc.) and four feature elements (i.e., Finance, Weather, etc.) from a previously broadcast or recorded news program. Segment icons 1706a designates the start and end points for each element. An editor or director preparing the program to be broadcast or re-broadcast would place segment icons 1706b at desired locations to insert, for example, a commercial feed or another story. In this example, segment icon 1706b would be used to cut Story 3, Story 6 and Story 10 at the indicated positions on the timeline. Hence, block 1720a designates the first section of the news program that precedes the first commercial feed inserted at block 1720b. Likewise, block 1720c designates the next section of the news program preceding the second commercial feed at 1720d, and so forth with respect to blocks 1720e, 1720f and 1720g. As intimated, the above example has been provided for illustrative purposes. As would be apparent to one skilled in the relevant art(s), other methodologies or techniques can be implemented to edit a media production and insert additional elements. For example, in lieu of cutting any portion of a video segment, the editor or director could shift the start or stop time for the respective element to make room for a new element (e.g., commercial) on the timeline. Additionally, the editor or director could adjust the properties defined by encode object 1710.

Control line 1704b is used for the placement of encode object 1710. Similar to start stream object 1602, data object 1604, and stop stream object 1606, encode object 1710 is configurable to instruct the encoding system to integrate metadata with the associated media segment(s) to label and catalog a show and specify auxiliary information to be transmitted with the media segment(s).

GUI 1700 also includes graphical controls that enable an editor or director to control or reconfigure the encoding process. Ready control 1504, start control 1506, stop control 1508, data control 1510, and reference window 1512 have been described with reference to FIG. 15. Approve control 1712 provides the director or editor with the ability to approve an encoded media production prior to being transmitted to streaming server 925.

In an embodiment, GUI 1700 is a component of a video editing processor. As pre-recorded video is processed by the editing station, GUI 1700 is operable to mark, reformat and edit the video consistent with the encoding commands associated with the appropriate icons 1706, 1708 and 1710. As such, the encoding system of the present invention can be used to provide enhance media content to any media production regardless of its source.

Referring to FIG. 18, GUI 1800 is another embodiment of an interactive rundown (e.g., post-production editing and approval application file 2409) encoding or editing encoded media productions. GUI 1800 includes a viewer 1801 that displays a media production during the encoding and post-production editing process. Viewer controls 1808 enables an operator to play, pause, stop, fast-forward, and/or rewind the production. In another embodiment, controls to “skip” to the next story or “skip back” to the previous story is provided. Text window 1802 displays various production and/or encoding commands as the operator reviews and edits the media production. Horizontal timeline 1102 interacts with viewer 1801. As a media production is displayed on viewer 1801, a timer (not shown) activates a timer indicator (not show) that travels across timeline 1102.

GUI 1800 also includes an URL control line 1804. An URL icon 1811 positioned on URL control line 1804 operates to synchronize and/or edit auxiliary information associated with the media production. If an encoder rundown (e.g., show rundown 2402 or shadow rundown 2404), such as the electronic rundown shown in GUI 1100 or 1200, is imported into GUI 1800, URL icons 1811 are automatically positioned by the encoder rundown. However, an operator can alter the position of an icon by activating the icon to open a window or dragging-and-dropping the icon with an input device.

A script control line 1805 enables an operator to synchronize and/or edit script with a media production. In embodiment, a script icon (not shown) is positioned onto script control line 1805 to associate script with the media production. Script icons can be automatically positioned with an encoder rundown is imported, or positioned by an operator. An operator can also activate a script icon to read or edit portions of the script. An operator can add script to a media production if it was omitted during an initial encoding process. An operator can also delete the script, as appropriate.

A story control line 1806 provides a visual display of each story with a media production. Input control line 1807 provides a user-friendly indication of specific locations within a story. Input control line 1807 displays still images of the beginning of video frame at a designated location. A user can use viewer controls 1808 to play the production so as to identify where to start and stop a story element. At any time during the editing or encoding process, an operator can activate approve control 1712, archive control 1809, and/or cancel control 1810. Approve control 1712 enables an operator to approve an encoded media production for archival. Archive control 1809 enables the media production to be archived for future recall. Cancel control 1810 deletes the media production and encoding instructions.

In an embodiment, an operator clicks and activates the image shown in input control line 1807 to perform various functions. For example, the operator can seek the beginning location of a video corresponding with the image shown in input control line 1807. The beginning of the video would display in viewer 1801. Similarly, the operator can seek the end location of a video corresponding with the image shown in input control line 1807. The operator can also interact with GUI 1800 to synchronize an image displayed on viewer 1801 image with an image displayed by input control line 1807, and vice versa. Upon synchronization, the operator can mark the synchronized images as being the end or beginning of an element. This feature is used to fragment a story element and to refine the start and end points of a story element. Accordingly, GUI 1800 permits an operator to edit and/or fragment stories into files for storage and on-demand recall.

As discussed in the above embodiment, to cut or fragment a media production, an operator manually enters a segment mark icon 1706 on GUI 1700, or uses the seek and synchronize features of GUI 1800 to instruct the encoding system to fragment the media at the designated location. An embodiment of a fragmentation process used by the encoding system is shown in FIG. 19. Flowchart 1900 represents an example of a control flow for fragmenting media productions according to the present invention.

The control flow of flowchart 1900 begins at step 1901 and passes immediately to step 1904. At step 1904, the encoding system uses a reader (not shown) to scan an input file that contains the media production. The encoding system also includes a timer (not shown) that is set at a start time (e.g., zero). From a beginning point within the file, the reader scans the media production until the reader detects the first keyframe used to designate a desired location for cutting. If no keyframe is detected, the control flow ends at step 1995. The encoding system can be configured to repeat the scanning processes of step 1904 for a predetermined number of times or time period, prior to passing to step 1995.

If a keyframe is detected, the control flow passes to step 1908. At step 1908, the reader suspends the scanning process and notes the keyframe time. The timer is also reset to the start time.

At step 1912, the reader restarts at the beginning point within the media production and collects uncompressed media (e.g., video and/or audio) until the timer reaches the time noted as the keyframe time.

At step 1916, the encoding system uses a writer (not shown) to write the uncompressed media (e.g., video and/or audio) through a codec device (not shown) for compression.

At step 1920, the mode is changed to reconfigure the reader to return compressed media and the writer to not use the codec device. The new beginning point is designated as being the point after the keyframe. Afterwards, the control flow returns to step 1904 to repeat the fragmentation process until all keyframes have been detected.

The fragmentation method embodied by FIG. 19 produces a newly cut file with a keyframe at the start of the clip instead of using delta frames. Additionally, the present invention provides a method for minimizing the requirements for recompression, which in turn improves the quality of the production. Since the entire clip does not have to be recompressed, the fragmentation method of the present invention imparts a significant improvement over conventional video editing methodologies, because the present invention permits faster, real-time productions and allows the encoding system to insert better start and stop points between segments that enable near seamless smooth transitions. In addition, conventional systems perform editing functions on uncompressed video. The present invention encodes video into a streaming format first, then edits accordingly.

In an embodiment, the encoding process of the present invention is implemented at multiple simultaneous rates. For example, a media production can be encoded simultaneously at 56 kbps, 100 kbps and 300 kbps. Therefore, the fragmentation process described in FIG. 19 can be performed in parallel with other encoding processes.

VIII. Auxiliary Information

As discussed above, a media production can be formatted to include various types of auxiliary information. Accordingly, the media streams transmitted to a display device includes instructions to present auxiliary information along with the media production. The auxiliary information includes, but is not limited to, advertisements, graphics, extended play segments, polling data, URLs, articles, animations, documents, court rulings, other data, and the like. As a result, the present invention provides the user with a multimedia and interactive experience that extends beyond the capabilities of traditional and personal television.

1. Advertisements

The present invention can be used to allow a broadcaster or other media hosting facility to automatically link advertisements to a specific show or show element/story by time, duration, and/or topic, or any other desired criteria. Advertisements include video or audio commercials; dynamic or static banners; sponsorship advertisements; pre-roll advertisements; active or passive advertisements; email correspondence, or like forms of media and multimedia promotions.

Video or audio commercials can be integrated into a media stream such that the commercial feed can be presented to the user while the user views the media production. For example, the commercial feed can be presented after one or more news stories, at the beginning of the media production, at the end, between scenes within a video production, or at any other place designated by the video director.

The advertisements also include banners. A banner includes any combination of text, graphics and other forms of media and multimedia that promotes a good or service, or otherwise provides information or an announcement. The banner can be strictly descriptive, or include hypertext, a hot spot, or a hyperlink to open additional banners, place an order, or send a request for additional information to the server of the host portal or another server. The banner can be a static banner that only displays the promotional advertisement. However, the banner can also be an active banner that blinks, spins, fades, and the like. The banner can also be a scrolling banner that includes a scroll bar that allows the user to move through contents of the banner. Resizable banners can also be used to allow the user to expand or enlarge the banner to receive more data. The aforementioned is a representative list of banners that can be used with the present invention, it should be understood that any other type of banner capable of promoting a product, including, but not limited to, banners developed with Macromedia® Flash™ or Macromedia® Shockwave®, or the like, as would be apparent to one skilled in the relevant art(s), could be easily included and would not change the scope of the invention.

The advertisements can also be active or passive. An active advertisement requires interaction from the user, such as clicking-through, scrolling and the like. Passive advertisements are displayed and require no interaction from the user. Additionally, the advertisements can take the form of pre-roll advertisements. Such advertisements are commercials, banners, or the like that are transmitted to the display device prior to the startup-of the media production.

As such, the present invention supports all types of advertisements that can be transmitted over a client-server network to a display device. As a video show is being transmitted, the advertisements are streamed at specified intervals and durations with the video show. In an embodiment, the advertisements are presented on the side panels of the same frame or window in which the video show is displayed. In another embodiment, the advertisements are streamed in separate frames. In another embodiment, the advertisements are streamed prior to the display of the related segment video. The advertisements can also include a hyperlink to a web site for the sponsor of the advertisement.

In an embodiment, metadata associated with an advertisement includes a copyright field that specifies any restrictions placed on the use or re-use of an advertisement. For example, a media host may not have a license to transmit a specific content on the Internet, but may have permission to provide the content over a private network or the airwaves, or vice versa. The advertisement can be restricted for educational uses, single broadcast, transmissions to designated clients, or the like.

Referring to FIG. 9, in an embodiment, media encoding system 940 queries advertising administration system 965 or AD server 935 to multiplex the advertisements with a media production. In another embodiment, streaming server 925 or enhanced media server 915 queries AD server 935 for an advertisement to be included with a media production. Thus, advertisements can be integrated into a media stream at any stage during media production.

Although either AD server 935 or advertising administration system 965 can manage the queries for advertisements from the other supporting system components, advertising administration system 965 is operable to create or edit advertisement media. Advertising administration system 965 can also be configured to format or encode the advertisements for transmissions.

AD IMS 970 interacts with advertising administration system 965, and stores advertisements for future lookup and retrieval. AD IMS 970 is an archival and retrieval system similar to media production IMS 950 and extended-media IMS 960.

Any ad developed with a hyperlink, can be “clicked-on” to request the advertiser's web page on the viewer browser. Browser activity on the viewer does not cause streaming to stop, pause or exit. The viewer remains active. If the user wants to browse the advertiser's web site, the player on the viewer provides for a pause control. A play control resumes the streaming process.

2. Supporting Information

In addition to advertisements, the present invention includes various features that enhance the content of the media streams. Referring to FIG. 9, in an embodiment, a video director or editor can operate media production system 945 or media encoding system 940 to link informative supporting media that enhances the related segment. In an embodiment, a separate frame is provided on a display for an enhanced media client 920 to present information, statistics, text, video, or like media or multimedia that are related to the media streams. For example, if a sports segment is being broadcast to show an interview of an athlete, in a separate frame, the current statistics for the interviewee can be presented for the user's perusal. Alternatively, the separate frame can include a menu of related data or web sites that online user can select. URL references can also be provided for the user to access, for example, more in-depth data.

In another embodiment, the informative supporting media or media enhancements includes captions or text corresponding to the segments as they are being viewed on enhanced media client 920. Therefore, in an embodiment, a transcript of the segment is synchronized and displayed in a separate frame from the video presentation. In another embodiment, the captions are integrated into the media streams of the show segment and displayed in the same frame as the video. In an embodiment, the captions or text is created by a character generator associated with media production system 945. In another embodiment, captions are generated by the teleprompting system (e.g., ParkerVision's SCRIPT Viewer™). The captioning feature can be activated or de-activated as necessary.

3. Extended Audio-Video

In an embodiment, the auxiliary information includes an extended audio or video segment (“extended media”). Extended media can be created and linked to a media productions in a variety of ways. For example, during an editing process, a video director or editor may decide to cut or fragment a show element. The element may be cut to save time or because of a breaking event that causes a change in the rundown. In such an event, the removed elements or a version of the element prior to editing is produced, encoded at, for example, extended-media encoding system 955 and stored in extended media IMS 960. A link to the extended media allows an online user to select and view the extended media on demand.

Extended media also includes additional stories in text, audio or video format that are related to a particular media segment. For example, a show element can be a news story related to the PGA Players Championship tournament. Extended media for the news story can include text of par scores, video interview of a player, live audio of the tournament in progress, text article related to golfing equipment, schedule of upcoming tours, and the like.

4. Opinion Research

In an embodiment, the present invention permits online polling or opinion gathering technologies to be integrated with a media production. The poll can be directed to the content of a specific show segment, a web page design for the hosting portal, preference for receiving advertisements, video presentation, and the like. For instance, in an embodiment, specific polls, surveys, and the like are created for specific show segments, and are cross-referenced and stored by the content production codes, URL, or the like identifying the show segments. When a show is assembled for broadcasts (live or on-demand), the appropriate poll is streamed at the designated interval with the related show segment. The poll can be presented on a display device in the same or a separate frame as discussed with regards to advertisements. During the broadcast, the portal's server receives the opinion data from the online users. In an embodiment, the opinion data is evaluated, and the results are returned to the display device in real time. In an embodiment, the portal's server provides the opinion results for an entire panel of respondents as well as the results for individual respondents. Reports can be generated and based on show, topic, advertiser, or the like for evaluation.

5. Hyperlinks to Related Sites

In an embodiment, the present invention uses hyperlinks to provide media enhancements. Based on the content of a specific show segment, a URL, email, or geographical address of individuals or organizations related to a show segment is generated, cross-referenced and stored in the archival and retrieval system. The URL address also includes the web site for electronic bulletin boards. When a show is broadcast, this data is presented on the display device with the related show segment. Accordingly, an on-line user can activate a hyperlink to visit or send a message to the designated site or individual that is related to the show segment that is currently being viewed. The request for the referenced web site activates the web site on the viewer browser without impacting the current status of the viewer or player.

6. Methods of Entering Auxiliary Information

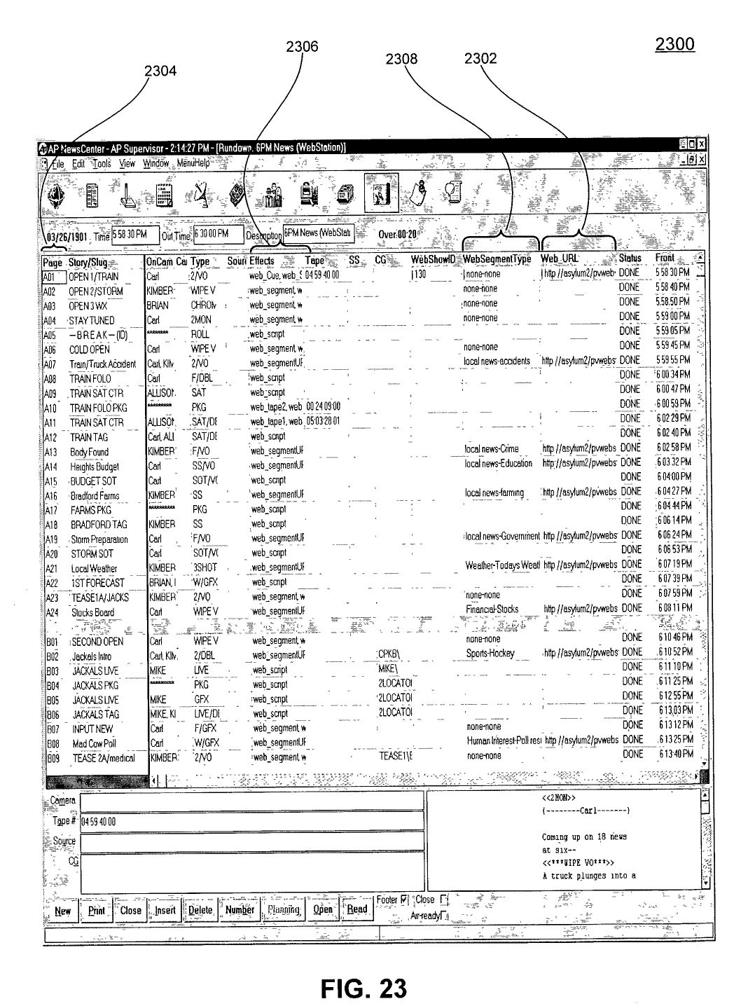

The present invention is configured to utilize a variety of techniques or methodologies to link auxiliary information, including advertisements, to a media production. In an embodiment for linking auxiliary information, a director or editor enters an URL, file identifier, or like designator in a “Web Link” column of a news automation system (described below in FIG. 23 as Web Link Column 2302).

A news automation system is a network of news production computers (not shown) within a newsroom environment. The news production computers are used to aggregate, edit, save or share news stories from a variety of sources among assignment editors, reporters, editors, producers and directors. The news sources include wire services or news services (such as, the Associated Press (AP), Konas and CNN services), police and fire information systems, and field reporters. A news automation system streamlines the show-building process and allows the producer or director to develop a rundown sheet and always know the status of stories during the rundown assembly process. As described above, companies such as iNEWS™ (i.e., the iNEWS™ news service available on the iNews.com web site), Newsmaker, Comprompter, or AP have developed news automation systems to manage the workflow processes associated with a newsroom operation.

FIG. 23 illustrates a rundown GUI 2300 for a news automation system according to an embodiment of the present invention. Rundown GUI 2300 lists all of the show elements by line item. Page Column 2304 delineates a corresponding line-item designator for each element listed in rundown GUI 2300. Each element is typically assigned a line-item, alpha-numeric designator such as A01, A02, A03, etc. Additionally, a newscast is typically assembled in blocks known as A, B, C and D blocks in a half-hour show. Thus, the first character in the line-item designator is used to identify a specific block.

Rundown GUI 2300 also includes one or more WEB Link columns 2302 for associating auxiliary information to an element. A director or producer would enter the URLs or like designator into WEB Link column 2302 by show element. For example, each element can be assigned a corresponding line-item, alpha-numeric designator such as A4, A3, and A5 (not shown) that may represent an “intro,” “package,” and “tag,” respectively, for a story. The producer or other responsible party can enter URL(s) within Web Link column 2302 for line A5 which is the “tag” or the end of the story. After the show has been executed and transmitted to an on-line user, the URL(s) would be presented on the display device during the “tag” section of the story. The URL(s) would, therefore, guide the user of the display device, for example, an extended play segment of the story.

Web segment classification column 2308 receives data from a standardized library of major and minor classifications. The standardized library helps keep all entries the same no matter who is entering the data. This library supports two separate applications. First, it supports the database organization of the lists that are presented to the viewer for selection by users. Second, it links the story to a category that allows the system to assign “targeted” ads. A numerical standard is used to prevent a broadcaster from making errors in spelling or terminology. The broadcaster can either enter the numerical identifier or select from a drop-down list.

Web effect column 2306 selects data from an established library of encoding acronyms. An encoding acronym identifies a specific file containing a “group” of commands that provides the post-production disposition instructions, including encoding instructions, for an element on a rundown. These commands would be entered on their respective control line(s) on an encoder rundown (such as, show rundown 2402 or shadow rundown 2404). In an embodiment, this grouping of commands to represent an element or group of elements on an electronic rundown is implemented with the Transition Macro™ Element (TME) file developed by ParkerVision, Inc. Accordingly, TME acronyms identify TME files associated with commands that populates an encoder rundown GUI (such as GUI 1100, 1200, or 1700) with the appropriate encoding instructions, as described above.

Provided below is an example of seven encoding acronyms (e.g., TME acronyms) that are implementable with the present invention for shadowing a newscast. The acronyms include “Show Open,” “Break,” “Segment for Archive,” “Segment for Live Only,” “Open Segment for Archive,” “Open Segment for Live Only,” and “Script.”

“Show Open” acronym is a two-step encoding acronym that first provides instructions to set a designated DVE to default values, video switcher to black on all busses, and audio mixer levels to a down position. The second step is initiated simultaneously with the start of the newscast. This step provides instructions for executing an encode mark 1106e to start the encoding process. Encode mark 1106e is set automatically when the acronym is imported into the electronic rundown, or it can be set manually with a show template prior to initiating the second step of this encoding acronym. The instructions from this encoding acronym can be modified after importation to support live archival encoding.

“Break” acronym is a single-step encoding acronym that initiates a break sequence within the encoding process. When executed, the encoding instructions from this acronym effectively stop the live stream and replace it with a stream generated from the encoder, itself. In an embodiment, the encoder-generated stream includes predefined video advertisements that have been created, sold, and/or trafficked for webcasting.

“Segment for Archive” acronym is a single-step encoding acronym that provides instructions to signal the encoder that material from this point is to be archived. In an embodiment, the encoding instructions also signal the encoder to classify the newscast from this point into a defined major and/or minor classification. This encoding acronym includes instructions for positioning an encode object icon 1106t to auto-populate the major and/or minor classification field upon importation into the electronic rundown.

“Segment for Live Only” acronym is a single-step encoding acronym that provides instructions to signal the encoder that material from this point is not to be archived. This encoding acronym is used to designate non-archival events of the newscast such as, opens, tags, teases, banter, etc. This encoding acronym can also be used to block copyright material from being archived. This acronym differs from the “Break” encoding acronym that the stream is still being web cast and not replaced with an alternate media source.

“Open Segment for Archive” acronym is a single-step encoding acronym that is identical to the “Segment for Archive” acronym with the exception that it must be used after a “Break” acronym. The reason is to initiate the video switcher to encode the newscast media from an alternate video ad media source.

“Open Segment for Live Only” acronym is a single-step encoding acronym that is identical to the “Segment Live Only” acronym with the exception that it must be used after a “Break” acronym. The reason is to initiate the video switcher to encode the newscast media from an alternate video ad media source.

“Script” acronym is a single-step encoding acronym that is used when multiple scripts are being used within one of the aforementioned live or archive “Segment” acronyms. This encoding acronym contains instructions for placing control icons to append a next script and to play that script.

The aforementioned encoding acronyms have been described by way of example and not of limitation. Other acronyms can be prepared and practiced with the present invention as would be apparent to one skilled in the relevant art(s).

When the encoding instructions of rundown GUI 2300 is imported into an encoder rundown, the encoder rundown pulls in the encoding acronyms (e.g., TME acronyms), Web Segment Type, and Web URLs, along with Script having embedded script commands such as URLs. In an embodiment, rundown GUI 2300 is configured to be automatically converted into a set of computer readable broadcast instructions. In an embodiment, the set of broadcast instructions is created from the Transition Macro™ event-driven application program as described in commonly assigned U.S. patent Ser. No. 09/822,855, filed Apr. 2, 2001, by Holtz et al., and entitled “Method, System and Computer Program Product for Full News Integration and Automation in a Real Time Video Production Environment” (herein referred to as “the '855 application”). The disclosure of the '855 application is incorporated herein by reference as though set forth in its entirety.

The present invention encompasses other methodologies or techniques for linking auxiliary information. In another embodiment, auxiliary information is entered in the script pertaining to a specific element. As discussed above, the present invention includes a teleprompting system (not shown) that permits an operator to enter various script commands. One type of script command is an enhanced media command that instructs a system component (such as, media production system 945 or media encoding system 940) to integrate media enhancements into a media production. As shown in FIG. 11 for example, auxiliary information, such as a URL reference or other identifier, can be embedded into a script that is sent to media encoding system 940 and viewable on text window 1110.

Script integration of media enhancements improves the timing pace that auxiliary information is displayed on a display device because script integration is a real-time synchronous method to link objects with video when the talent is reading about the specific topic that the object references. For example, the talent may be reading a financial report about two separate companies. When discussing Company A performance, a graphic object with the companies stock or financial data can be displayed synchronized with the video. When Company B is discussed, the object changes to reflect Company B data. In this example, the director does not step into another segment to trigger an object, but the topic changes while the talent remains on the program output. In this application, script commands offer better control and synchronization.

Accordingly, in an embodiment, a teleprompting system sends messages (i.e., script commands) directly to an encoder that formats media productions to be transmitted over a computer network (i.e., network infrastructure 910), but does not necessarily initiates the encoding process. The teleprompting system sends script text to the encoder for captioning and/or full text indexing. The teleprompting system is also configurable to send URL links or the like. Sending URL links from the teleprompting system is especially important for timing data window transitions (that can be viewed in text window 1110) with scripts if the talent video shot does not transition. In other words, if a topic changes without a video transition during a media production, then an URL associated with the topic can be triggered via a script command. The script command is inserted in the script that the talent is reading to time the data window content (i.e., the text being read by the talent as it rolls in text window 1110) to the topic.

On the other hand, if a video transition is required when a topic changes, the URL associated with the topic is triggered from a media production command integrated within an electronic rundown. Thus, in another embodiment, media enhancements are entered via an interactive electronic rundown such as GUI 1100 shown in FIG. 11. As discussed, GUI 1100 supports two methods for linking enhanced media to a media production. One method pertains to the placement of icons 1106 (namely, data objects 1604) onto control line 1104p. As described with reference to FIG. 16, GUI 1600 permits an operator to configure data object 1604 to include various properties, including links to enhanced media. A reference field (not shown) is included in GUI 1600 to permit an operator to enter a file identifier, URL data, or the like for the enhanced media.

In another embodiment, media enhancements are linked to a media production directly from a field provided on an interactive electronic rundown, such as GUI 1100. As discussed with reference to FIG. 15, data control 1510 is used to enter auxiliary information and link the information to a specific segment or an entire show. The auxiliary information is entered by typing the URL reference or other identifier in reference window 1512 and activating data control 1510. Accordingly, in an embodiment, an electronic rundown is responsible for preparing an encoder, starting encoding, sending URL links, and stopping encoding.

IX. Viewer Interface

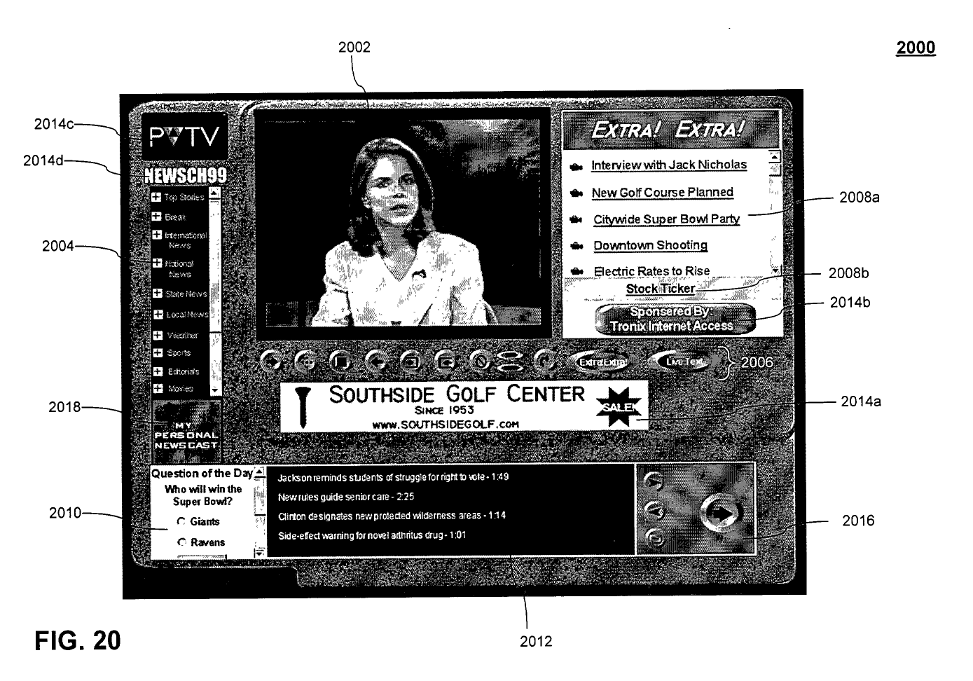

FIG. 20 illustrates streamer 2000 for use with a display device (e.g., enhanced media server 920) according to an embodiment of the present invention. Streamer 2000 is a textual or graphical user interface that provides a common platform for integrating one or more of the following components: a media viewer 2002, media index 2004, viewer controls 2006, auxiliary media 2008a-2008b, opinion media 2010, media access area 2012, banners 2014a-2014d, media access controls 2016, and index button 2018. As illustrated, streamer 2000 is configured to display each component in the same frame or window. However, in another embodiment, one or more of the components are displayed in a separate frame or window.

Streamer 2000 is generated by an application operating on a display device. In an embodiment, enhanced media server 915 transmits an XML application to instruct a browser application operating on enhanced media client 920 to create the requisite components of streamer 2000. Other programming applications can be used as would be apparent to one skilled in the relevant art(s).

1. Media Viewer

Media viewer 2002 is responsive to user commands to display on-demand and live media productions. In an embodiment, media viewer 2002 is operable to demultiplex media streams to support picture-in-picture (PIP) functionality. Accordingly, media viewer 2002 is configurable to display multiple media productions in the same or a separate window.

In an embodiment, a user would initiate a session with enhanced media server 915, and assemble an on-demand multimedia presentation. The user has the option of requesting to watch a live presentation. If the user prefers to view a different show, the user can override the live presentation to view a previously aired show in its entirety or components of the show in the preferred arrangement.

Although media viewer 2002 is designed to display video, in an embodiment of the present invention, media viewer 2002 is configurable to only play audio without any video. This embodiment is used to support a radio broadcast as described above, or receive audio feeds from other web sites. In general, viewer 2002 can support input of any multimedia type or format.

2. Viewer Controls

Viewer controls 2006 are responsive to user inputs to alter or control media viewer 2002. In an embodiment, viewer controls 2006 enable the content displayed by media viewer 2002 to be started, fast-forwarded, reversed, stopped or paused at any time. Moreover, an entire segment within a show can be advanced or skipped forward or backward as desired by the user. Other controls include captioning. For instance, the script containing the text of a newscast can be displayed by media viewer 2002 below or over the current video. The text can also be displayed in a separate area.

Viewer controls 2006 are also operable to support online recording, volume controls, parental locks, PIP functionality, viewer size, multiple languages, stereo sound, and the like. In an embodiment, viewer controls 2006 include an interrupt button (not shown). For example, if enhance media client 920 receives a breaking news update, streamer 2000 can be configured to signal the user. The user would have the option of activating viewer control 2006 to implement an interrupt to either watch the breaking news update immediately or save the news update to a file for future viewing. The interrupt button (not shown) for viewer control 2006 can also be used with a commercial advertisement. The user could activate the interrupt button (not shown) for viewer control 2006 to pause or save the commercial advertisement to a file for future viewing.

In an embodiment, viewer controls 2006 include preset buttons (not shown). The preset buttons (not shown) for viewer controls 2006 can be activated to receive transmissions from, for example, a favorite television or radio station.

3. Media Index

Media index 2004 displays a listing of available media productions that can be selected and displayed by media viewer 2002. In an embodiment, media index 2004 contains the rundown from a specific show, or a listing of all shows available from a hosting web site. In another embodiment, media index 2004 contains a personalized listing of shows identified by a user. In an embodiment, the user establishes a profile to specify shows by topics or category, specify duration for the entire media production, enable breaking news updates, specify a start time, designate a fixed or flexible end time, or the like. The profile can be saved for future use. Index button 2018 is used to toggle between a personalized listing and general listing in response to user input.

Media index 2004 supports keyword searches for content in the archival and retrieval system of system 900. In an embodiment, SQL queries are sent to enhanced media server 915, which queries IM server 930 for the requested content.

Media index 2004 permits users to save content as they wish for later requests or to build an archive of related stories for use in a report, thesis, or other interests.

4. Auxiliary Media

In an embodiment, streamer 2000 demultiplexes media streams from enhanced media server 915 to display auxiliary media 2008a-2008b. Auxiliary media 2008a includes extended media, caption data, graphics, web links, and the like. Activating a viewer control 2006 (shown as “ExtraExtra” and “Live Text”) permits one to switch between caption data and other auxiliary information. Auxiliary media 2008b, in a representative embodiment, is a hyperlink or hot button for a stock ticker or the like. The stock ticker can be supplied or sourced by the broadcaster or via any other source (such as the Internet), and can be either a standards-based ticker or customized to only illustrate the symbols of choice by the user.

5. Opinion Media

In an embodiment, streamer 2000 demultiplexes media streams from enhanced media server 915 to display opinion media 2010. The online user may interact with streamer 2000 to participate in a poll, take a survey or review the opinions of other respondents.

6. Media Access Area

Streamer 2000 also includes a media access area 2012. In an embodiment, media access area 2012 is a web browsing region that permits the user to visit and view other web sites without leaving media viewer 2002 or interrupting a current show displayed by media viewer 2002. Hence, both windows are active such that media access area 2012 can be used to research information without having to leave media viewer 2002. This avoids time-consuming loading, buffering and reloading when the user wishes to go back to the in-progress program on media viewer 2002.

Media access area 2012 is also used as the browser for URL links that are activated from auxiliary media 2008a-2008b. In another embodiment, media access area 2012 displays an online user's rundown of the selections from media index 2004. The selections can be placed in any order or re-ordered are indicated by the user.

Media access controls 2016 permits the user to manipulate the selections displayed in media access area 2012. Media access controls 2016 includes a scroll buttons that instructs the media access area 2012 to caret up or down. Media access controls 2016 also includes a delete button for removing selections and a play button for sending a request to enhanced media server 915 for the selections.

Media access area 2012 is also configurable to permit users to submit questions to a Webmaster or network systems administrator for a broadcasting station or portal host. A user can also search a specific topic tied to a media production, such as a newscast. In an embodiment, each time a user selects a topic from the search results, advertisements linked to the topic are routed to the user. Streamer 2000 or enhanced media server 915 is also configurable to support monitoring and data logging to track web hits, advertisement hits, billing and costs. In an embodiment, streamer 2000 or enhanced media server 915, supports communications with independent media measurement entities, such as, Nielson/Net-Ratings, Media Metrix and Arbitron for the development of independent industry reports.

7. Banner

Streamer 2000 also processes the media streams from enhanced media server 915 to display banners 2014a-2014d. Advertisement banner 2014a is a static or dynamic banner that promotes the goods or services of a sponsor. Advertisement banner 2014a can be active to require the user to scroll or click-through the banner, or passive to require no action on part of the user. In an embodiment, the sponsor can be linked to a specific segment displayed by media viewer 2002.

Advertisement banner 2014b is a sponsor button or mark linked to the media production. In an embodiment, advertisement banner 2014b is linked to a segment currently displayed by media viewer 2002 and advertisement banner 2014b is linked to the web page in general.

Advertisement banners 2014c-2014d are used to promote the hosting web site or portal. Advertisement banners 2014a-2014d can be a hot spot, hyperlink or nonfunctional.

8. Alternative Skins

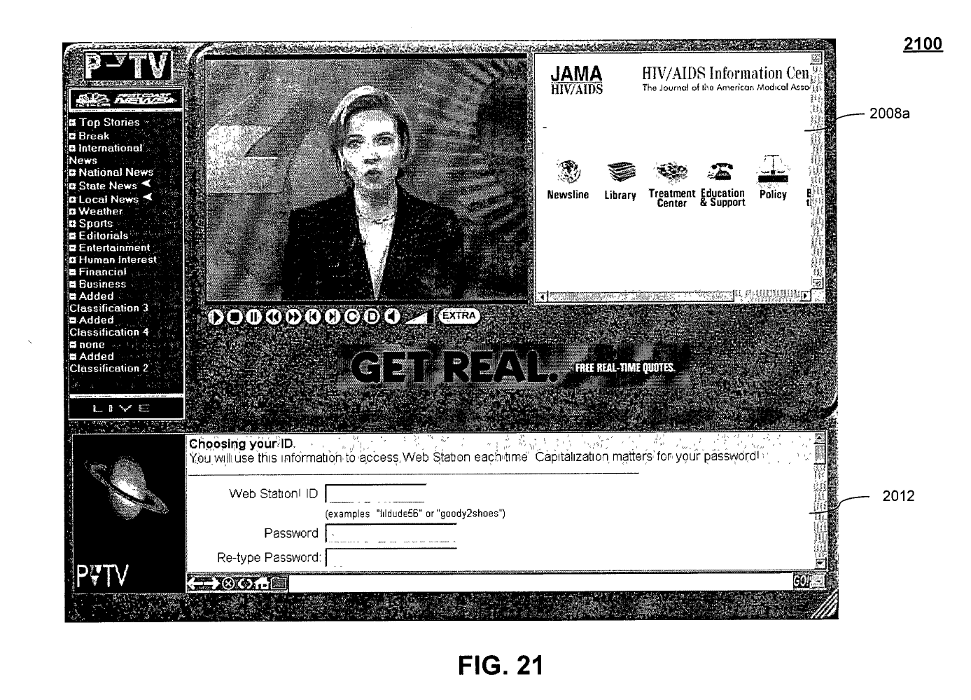

FIG. 21 illustrates another embodiment of a client GUI (shown as streamer 2100) for use with an enhanced media server 920. In streamer 2100, media access area 2012 provides a login menu that enables a user to access the content of enhanced media server 920. Auxiliary media 2008a displays an HTML page from a web site that is linked to the current media stream shown by media viewer 2002.

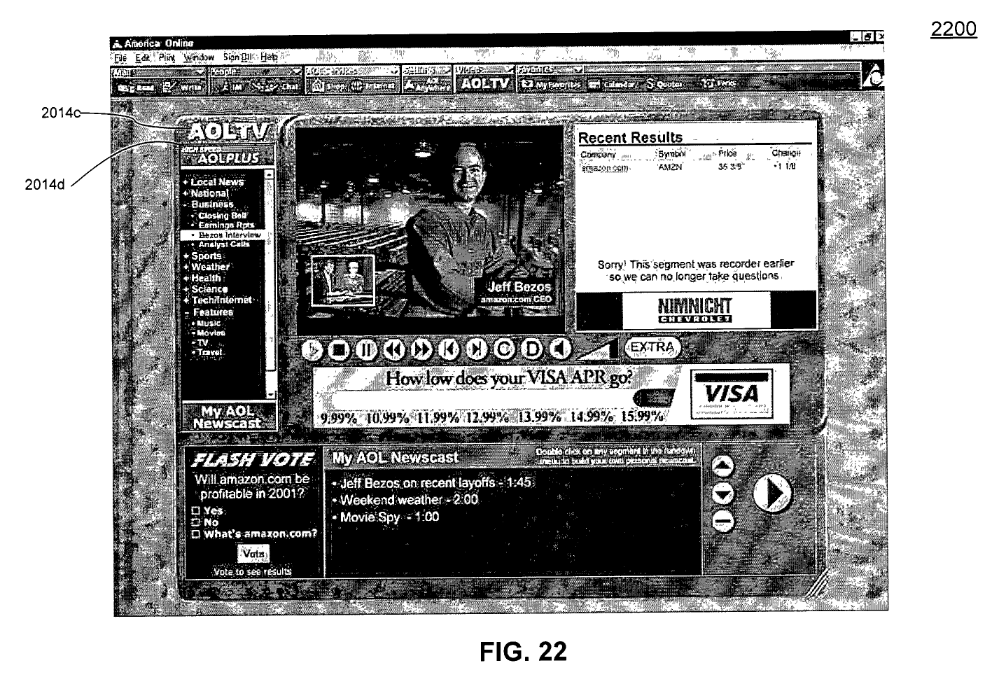

The above streamer embodiments have been described with reference to the hosting site being the actual broadcaster or content suppler. As such, the streamer components are implemented in the web site hosted by the local broadcaster. The present invention can also be implemented with a third party portal. An embodiment of a third party GUI is shown in FIG. 22. Streamer 2200 permits the streamer components to be presented on a third party GUI with the third party host identified by advertisement banners 2014c-2014d.

X. Conclusion

The foregoing description of the specific embodiments will so fully reveal the general nature of the invention that others can, by applying knowledge within the skill of the art (including the contents of the documents cited and incorporated by reference herein), readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the art.

While various embodiments of the present invention have been described above, it should be understood that they have been presented by way of example, and not limitation. It will be apparent to one skilled in the relevant art(s) that various changes in form and detail can be made therein without departing from the spirit and scope of the invention. Thus, the present invention should not be limited by any of the above-described exemplary embodiments, but should be defined only in accordance with the following claims and their equivalents.

What is claimed is:

1. A method of editing and distributing media throughout a network, comprising the steps of:
(1) receiving media from a production, wherein said production comprises one or more elements of a story;
(2) editing association of auxiliary information with said story; and
(3) enabling display of said media and said auxiliary information at one or more media clients.

2. The method of claim 1, further comprising the step of:
(4) deliverying said production over one or more television mediums.

3. The method of claim 2, wherein step (3) and step (4) occur substantially at the same time.

4. The method of claim 2, wherein step (3) and step (4) occur substantially at the same time as producing said production.

5. The method of claim 1, further comprising the step of:
(4) converting said media into one or more packets.

6. The method of claim 5, wherein step (2) comprises the step of:
(a) adding a header to at least one of said one or more packets to associate said auxiliary information with said story.

7. The method of claim 5, wherein step (2) comprises the step of:
(a) associating an address to the location of said auxiliary information to associate said auxiliary information.

8. The method of claim 7, wherein step (2) further comprises the step of:
(b) specifying said address in a header appended to at least one of said one or more packets.

9. The method of claim 5, further comprising the step of:
(5) formatting said one or more packets for transport to said one or more clients.

10. The method of claim 9, wherein step (5) comprises the step of:
(a) formatting said one or more packets for compliance with a TCP over IP protocol suite.

11. The method of claim 9, wherein step (5) comprises the step of:
(a) formatting said one or more packets for compliance with an HTTP protocol.

12. The method of claim 9, wherein step (5) comprises the step of:
(a) formatting said one or more packets for compliance with a RTP protocol.

13. The method of claim 1, further comprising the step of:
(4) transmitting said media and said auxiliary information to said one or more clients.

14. The method of claim 13, wherein step (4) comprises the step of:
(a) transmitting said media and said auxiliary information over a computer network to said one or more clients.

15. The method of claim 13, wherein step (4) comprises the step of:
(a) transmitting said media and said auxiliary information to said one or more clients over a least one of an intranet, an extranet, a virtual private network, and the global Internet.

16. The method of claim 1, wherein step (2) comprises the step of:
(a) associating auxiliary information with a corresponding element of said story.

17. A method of editing encoded media, comprising the steps of:
(1) receiving encoded media representing a production;
(2) modifying association of auxiliary information to one or more elements of said production; and
(3) storing said encoded media such that elements of said production are retrievable.

18. The method of claim 17, further comprising the step of:
(4) receiving a request from a client for one or more elements of said production.

19. The method of claim 18, further comprising the step of:
(5) transmitting instructions enabling presentation of one or more elements identified in said request to occur concurrently with a corresponding associated auxiliary information.

20. The method of claim 17, further comprising the step of:
(4) storing instructions for displaying said auxiliary information, wherein said auxiliary information corresponds with the element being displayed on one or more clients.

21. The method of claim 17, further comprising the step of:
(4) formatting said encoded media for transport to one or more clients over the global Internet.

22. A computer data signal embodied in a transmission medium, comprising:
a first code segment including instructions for displaying one or more stories; and
a second code segment including instructions for displaying auxiliary information corresponding to at least one story, such that said auxiliary information is displayed concurrently with a corresponding story.

23. The computer data signal according to claim 22, further comprising:
a third code segment including instructions for transmitting to an enhanced media server a request for additional auxiliary information.

24. The computer data signal according to claim 22, further comprising:
a third code segment including instructions for displaying auxiliary information corresponding with an element of said at least one story, such that said auxiliary information is displayed concurrently with a corresponding element.

25. The computer data signal according to claim 22, wherein said auxiliary information includes at least one of extended media, an URL address, an opinion poll, an email address, statistics, graphics, a text document, or an advertisement.

26. The computer data signal according to claim 22, further comprising:
a third code segment including instructions for requesting a customizable selection of one or more stories and/or one or more elements of a story.

27. A computer program product comprising a computer useable medium having control logic embedded in said medium for causing a computer to edit and/or distribute media, said control logic comprising:
first means for causing the computer to receive media from a production, wherein said production comprises one or more elements of a story;
second means for causing the computer to associate auxiliary information with said story; and
third means for causing the computer to enable display of said media and said auxiliary information at one or more enhanced media clients.

28. The computer program product according to claim 27, wherein said third means is adapted to enable said display to occur at substantially the same time as a broadcast of said media over another distribution medium.

29. A system for editing encoded media, comprising:
first means for receiving encoded media representing a production;
second means for modifying association of auxiliary information to one or more elements of said production; and
third means for storing said encoded media such that elements of said production are retrievable on an on-demand basis.

30. The system of claim 29, further comprising:
fourth means for receiving a request from a client for one or more elements of said production.

31. The system of claim 30, further comprising:
fifth means for transmitting instructions enabling presentation of one or more elements identified in said request to occur concurrently with a corresponding associated auxiliary information.

32. A method of transmitting information within a communications network, comprising the steps of:
(1) accessing one or more topics corresponding to a user profile;
(2) assembling a media production matching the one or more topics; and
(3) enabling display of the media production to the user.

33. The method of claim 32, wherein step (1) further comprising the step of:
(a) receiving the one or more topics from the user.

34. The method of claim 32, wherein step (1) further comprising the step of:
(a) inferring the one or more topics from psychographic data.

35. The method of claim 32, wherein step (1) further comprising the step of:
(a) parsing a calendar to identify the one or more topics.

36. The method of claim 32, wherein step (2) further comprising the step of:
(a) setting a user-specified duration of the media production.

37. The method of claim 32, further comprising the step of:
(a) enabling formatting of the media production to match formats specified by the user.

38. The method of claim 32, further comprising the step of:
(a) transmitting a media production related to traffic and/or weather during a commute of the user.

39. The method of claim 32, further comprising the step of:
(a) enabling display of the media production at a time designated by the user.

40. The method of claim 32, wherein step (2) further comprises the step of:
(a) selecting video, documents, web links, audio feeds, or commercial offers to assemble the media production.

41. A computer program product comprising a computer useable medium having control logic embedded in said medium for causing a computer to transmit media productions, said control logic comprising:
first means for causing the computer to access one or more topics corresponding to a user profile;
second means for causing the computer to assemble a media production matching the one or more topics; and
third means for causing the computer to send the media production to the user.

42. The computer program product according to claim 41, further comprising:
fourth means for causing the computer to determine the one or more topics from psychographic data.
